(19) United States
(12) Patent Application Publication
(10) Pub. No.: US 2006/0271281 A1
(43) Pub. Date: Nov. 30, 2006

(54) Geographic information knowledge systems

(76) Inventors: Myron Ahn, Pasadena, CA (US); Matthew Schnitz, Pasadena, CA (US)

Correspondence Address: COURTNEY STANIFORD & GREGORY LLP, P.O. BOX 9686, SAN JOSE, CA, 95157, US

(21) Appl. No.: 11/437,235

(22) Filed: May 20, 2006

Related U.S. Application Data
(60) Provisional application No. 60/683,139, filed on May 20, 2005.

(51) Int. Cl. G01C 21/32

(52) U.S. Cl. 701/208; 340/995.1

(57) ABSTRACT

Systems and methods are described for managing geographically referenced data (GRD). The systems and methods are configured to receive a search request that includes a defined search area. An extended map is provided based on the search request. The extended map includes geographic areas within the defined search area and outside the defined search area. The systems and methods provide the GRD, which includes advertisements, contact information, review information for one or more entities, and the like. Map reference information of the GRD is provided on the extended map.

### RELATED APPLICATION

This application claims the benefit of U.S. Patent Application No. 60/683,139, filed May 20, 2005.

### FIELD OF THE INVENTION

The present invention is related to managing geographically referenced data (GRD) and, more particularly, to associating maps with the GRD and using the maps to search the GRD and using a text search engine to perform spatial searches of the map.

### BACKGROUND

Certain areas in a city or town have certain reputations—for example, it is better to live in the west side of town rather than the east side; restaurants north of a certain street serve better food or have a certain ambiance desired by the user; and the schools in this district better educate/prepare children than those in other districts. Thus, a way to enable users to search user-defined regions is highly desirable.

Many companies store information in relational database management systems (RDBMS) without spatial indexing capabilities. Although these RDBMS may approximate spatial indexing by storing the x, y coordinates, or x, y, z or multi-dimensional coordinates, searches performed using such information are very cumbersome and time consuming. A way to facilitate spatial searches using conventional RDBMs is thus desirable.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

FIG. 1 is a block diagram of a geographic information knowledge system (GIK system), in accordance with an embodiment.

FIG. 2 is a block diagram of a map manager, including modules and databases, in accordance with an embodiment.

FIG. 3 is a diagram of an embodiment of a client device.

FIG. 4 is a data flow block diagram of how requests of maps are handled within the GIK system, according to an embodiment.

FIG. 5A is an example user interface, showing for example, a window or a web page on a web browser, according to an embodiment.

FIG. 5B is another embodiment of an example user interface but having a different layout from FIG. 5A, according to an embodiment.

FIG. 5C is another example user interface wherein the user defines one user search area, according to an embodiment.

FIG. 5D is another example user interface wherein the user search area consists of more than one search region.

FIG. 6 shows a flowchart of an example search, according to an embodiment.

FIGS. 7A and 7B show two example extended search areas or maps, according to an embodiment.

FIG. 8A is another example interface showing the map area of the window or page displayed in FIGS. 5C and 5D.

FIG. 8B is another example user interface showing another embodiment of the invention.

FIG. 9 is an illustration of an example manner in which a map may be divided into various sections for advertising purposes, according to an embodiment.

FIG. 10 is an example flowchart of a method by which the advertising feature is provided, according to an embodiment.

FIGS. 11A through 11D show how an area may be subdivided into sub-areas/regions/quadrants having each region represented by an associated spatial key, according to an embodiment.

FIG. 12 is a graphical representation of another example map, according to an embodiment.

FIG. 13 is a graphical illustration of a user network comprising a plurality of users implemented in the GIK system that may be implemented in accordance with another embodiment.

FIGS. 14A-14E show graphical illustrations of how, in one embodiment, the example contact connection affinity network in a GIK system is created.

### DETAILED DESCRIPTION OF THE INVENTION

Systems and methods are described below for managing geographically referenced data (GRD). The systems and methods, collectively referred to herein as geographic information knowledge (GIK) systems, are configured to receive a search request that includes a defined search area. An extended map is provided based on the search request. The extended map includes geographic areas within the defined search area and outside the defined search area. The systems and methods provide the GRD, which includes advertisements, contact information, review information for one or more entities, and the like. Map reference information of the GRD is provided on the extended map.

The GIK systems of an embodiment provide spatial key indexing by dividing the geographic areas into one or more regions. While supporting spatial searching with a text database, the GIK systems eliminate the use of a specialized spatial database to do spatial searching. One or more spatial keys are assigned to each of the one or more regions, and the regions are represented as nodes of a tree. The tree of an embodiment includes one or more of a quad tree, an N-tree, wherein N represents a number of subdivisions per region, a binary space partitioning tree, and a KD-tree, wherein a KD-tree is a multi-dimensional search tree for points in K-dimensional space. The GIK systems are configured to provide spatial text indexing by associating each of the spatial keys to one more physical locations of the extended map. Associating each of the spatial keys to one more physical locations of the extended map includes associating the spatial keys to one or more of location data, addresses, coordinates, and latitude and longitude data of the physical locations of the entities. The GIK systems of an embodiment are configured to perform queries corresponding to the search request. The queries include one or more of substring queries of the spatial keys and prefix substring queries of the spatial keys.

In the following description, numerous specific details are introduced to provide a thorough understanding of, and enabling description for, embodiments of the GIK systems. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

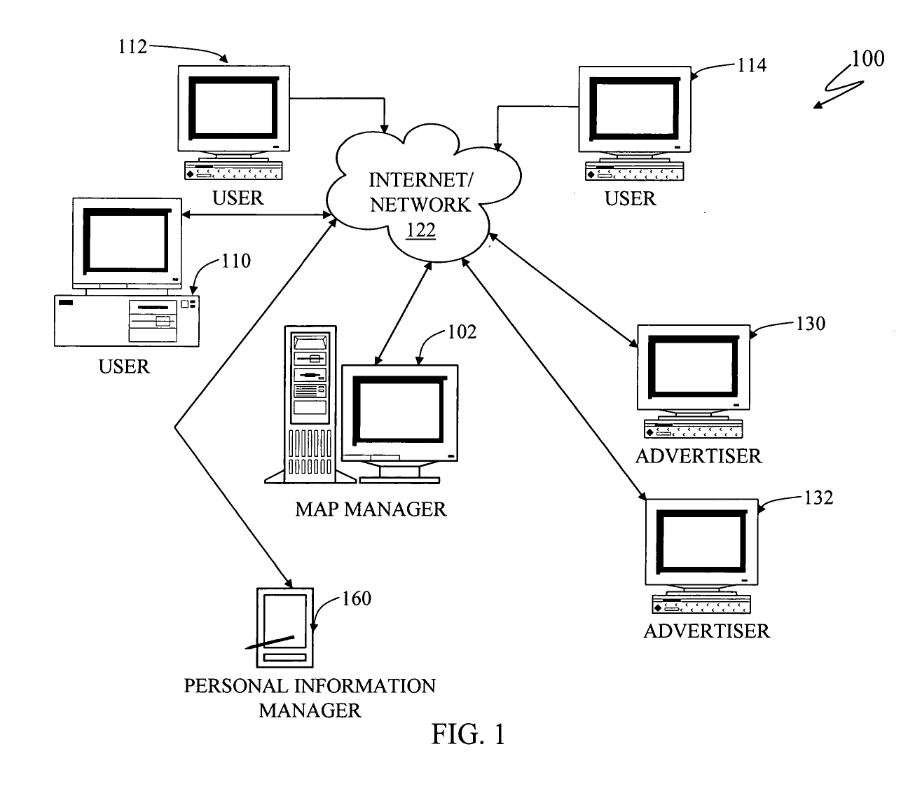

FIG. 1 is a block diagram of a geographic information knowledge system (GIK system) 100, in accordance with an embodiment of the invention. The GIK system 100 in general enables users to search using maps. The GIK system 100 in one embodiment includes a map manager, which in an embodiment includes a server 102, wherein several client devices such as computer devices or terminals 110, 112, 114, 130, 132, 160 are coupled to the map manager 102 via a wired or wireless network 122, such as the Internet, wide area network, local area network, and/or an intranet. The map manager 102 of an embodiment functions as a website and may include one or more servers. In another embodiment, advertisers 130, 132 may also be coupled to the map manager 102 via a network 122.

In general, the users of the GIK system 100 connect with the map manager 102, which serves up web pages and implements some of the features of the present invention. In another embodiment, the map manager 102 responds to requests for data by client devices 110, 112, 114, 160, 130, 132. The data received by client devices from the map manager 102 are accordingly processed and presented in a user interface. The client computer systems or devices may be users of the network 110, 112, 114, 160 or advertisers 130, 132. These client devices 110, 112, 114, 160, 130, 132 may also be other network-enabled devices, including, but not limited to, Web-enabled wireless phones, personal digital assistants (PDAs), smart phones, Internet-enabled game devices, e.g., XBOX™ and PlayStation™, and interactive televisions. These client devices enable users to interface with the map manager 102 using various mechanisms, including, but not limited to, keyboard entries, voice-activated commands, touch-tone phone interfaces, and touch screens.

In one embodiment, advertisers 130, 132 may interface with the map manager 102 enabling advertisers 130, 132 to bid for, or purchase, advertisement spaces or regions within the maps. Advertisements are associated with the map or maps presented to users, and can be related to a physical presence, such as a retail store, within a geographic area. Advertisers may purchase or place a bid on one or more advertising regions of a map. A certain area of a map, in general may have a number of advertisements related to that map area.

A system of an embodiment associates an ad with both a bid and a set of locations (e.g. lat/lon). For example, Company A wants an ad for all of its locations in Los Angeles, Calif. to fall under one bid. When a user looks at a region on the map, ads with the top N bids with points within the visible map region are displayed.

Other criteria can be used to rank ads with points within a visible map region, such as top revenue generators (click-through rate times bid price). Additionally, other filters can be used to increase the relevance of an ad. An example of one such filter is whether the ad is associated with keywords that the user provided during his/her search, whether the ad is associated with the category specified by the user, and/or whether the ad matches the user's age, demographics, preferences, or other metadata.

As an example, if someone is looking at all of California, the three (3) highest ranking ads with points within California will be displayed. If someone is looking at a one-block area within Pasadena, the highest ranking ads within that block will be displayed.

As the user scrolls the map, different ads will be displayed depending on which ads have points within the visible region. The ad candidate selection is based on the region being displayed which determines which ads have points within that region, and the ranking algorithm. For greatest relevance, the points would be associated with the advertiser location, e.g. if you scroll over a McDonalds, and it is the highest ranking ad in that region, a little star might appear by the McDonalds.

Generally, advertisers can declare a geographical target region for their ad. This target region can be a point, a set of points, a point and radius, many point-radii combinations, a zip code, multiple zip codes, an arbitrary shape or disjoint set of shapes, the entire United States, etc. The target region will probably have some relevance to the location of the advertiser but is not so limited.

The Advertiser or ad is associated with other metadata included within the system or entered directly or indirectly by the advertiser or other users, or deduced from this data or usage of the system. A bid price may be included in this metadata, or perhaps a bid based on certain criteria such as keywords or categories.

The user performs a search and is presented with a map with a visible region containing results. A function of an embodiment determines whether an ad is a candidate for this user. The function takes into account the search keywords or criteria, the visible region of the map, the user and his metadata, the geographical target region of the ad, and the metadata of the ad.

A function is then used to determine the ranking of this ad. This function can take into account all of the above but likely it will focus on the bid or the maximum revenue (click-through or call-through rate*bid price). The ad candidates are sorted by ranking and the top N candidates are displayed to the user. This establishes a dynamic advertising bidding market based on the region being viewed by the user. The region can be any arbitrary region having any size and/or shape.

The GIK system 100 of an embodiment is configured to facilitate map searching, as well as provide other information, such as advertisement-related information. One embodiment of the invention, for example, enables users to conduct searches via maps. A user of an embodiment is able to define a user search area, which may be of any shape (e.g., square, rectangle, customized shape that encompasses a region according to one or more parameters that include, for example, a neighborhood, zip code, school district, city, and/or other boundary). The user, optionally, may also add other search criteria, such as query terms, to narrow the search. An extended map which is wider or has a larger region than the user-defined search area is provided to the user in an embodiment in response to the user's search request. Thus, if a user desires to search outside of the user's original search area, a request for additional map information from the map manager in some cases may be eliminated or alleviated. That is, in cases where the user decides to search outside of the user's original search area, the request for that additional area may be quickly responded to by the client device by merely accessing local data from the extended map rather than querying the map manager for additional information via a network 122, thereby providing faster response time (i.e. in the case of scrolling). Thus, additional requests for maps and other information are generally only sent to the map manager when the user search area is outside the extended search area, rather than outside the user's original search area. In one embodiment, the map manager 102 responds to a request by providing the entire map area requested, including the extended area, but in another embodiment, only map updates or map differentials, meaning maps not available at the client side, are sent to the client computing device. The information presented to the user in response to a search includes a set of information, including, for example, the map, locations of entities satisfying the search results, ratings of such search results, and detailed information about entities.

In one embodiment, a user search is not required to bring out a resulting web page. Instead, a default web page based on certain conditions is presented to the users. This is used in the case of an anonymous user where the system deduces the user location and possible context (perhaps based on referrer) and serves up a good guess for a relevant map and results and advertisers.

In another embodiment of the invention, a revenue stream is generated by associating advertisements with the map. The map in general is divided into one or more advertising spaces or regions, which advertisers may purchase at a listed or bid price, without having the advertisers have actual physical presence, such as retail stores, on those advertising regions. In one embodiment, the same map, and even the same advertising region, may be associated with a different set of advertisers. For example, if the user is from California and the user requests the entire map of California, an ad from Advertiser 1 is shown; while if the user is from Arizona and the user requests the entire map of California, an ad from Advertiser 2, however, is shown. Accordingly, in this example embodiment, the manner in which one or more advertisements are associated with an advertising space or region may depend in general on the advertising scheme in place. This advertising scheme may be based on one or more factors, such as the requesting user's general physical location and advertising spaces.

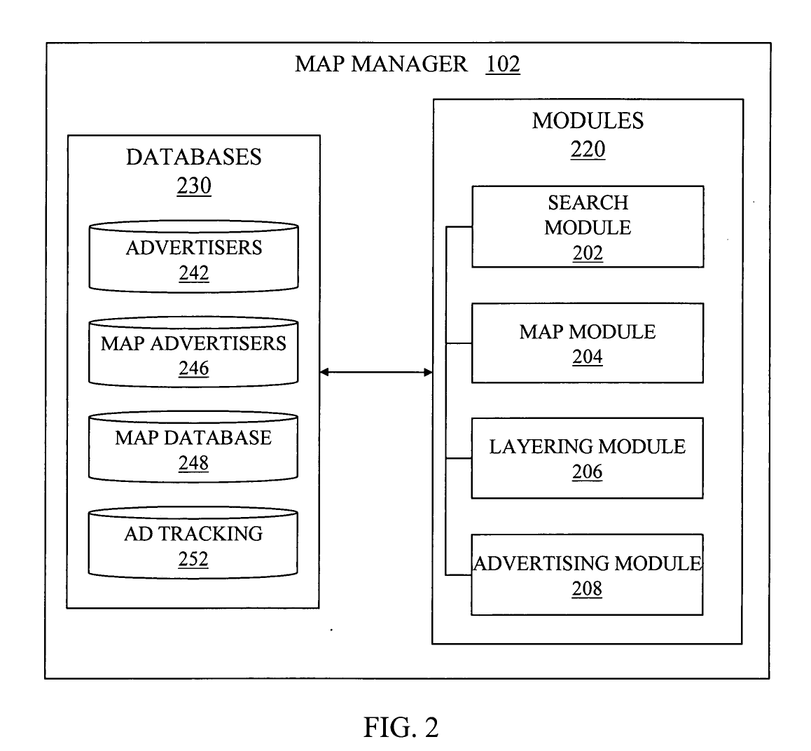

FIG. 2 is a block diagram of a map manager 102, including modules 220 and databases 230, in accordance with an embodiment of the invention. These various modules 220 may be replicated and/or distributed over one or more computer servers. These modules 220 in general are sets of program codes, functions, processes, program instructions, and/or applications that are executable by computing devices, like computers, to perform the features of the present invention. These modules interface with each other (interface connections or arrows not shown) but are not so limited.

The map manager also includes one or more data stores containing information about advertisers 242, map areas and related advertisers 246, maps 248, advertising statistics or transaction history 252. These data stores may be databases, such as relational database management systems, object-oriented database management systems, linked lists, arrays, flat files, comma-delimited files, and the like. In an embodiment, however, data are stored in relational database management systems (RDBMS).

The advertisers database 242 generally contains advertiser information, such as name, address, current balance, and the like. The map-advertiser database 246 contains advertising regions and their associated ads. The map database 248 generally contains map information, such as vector or raster data or any other types of data, to generate maps. The ad tracking database 252 generally contains statistics of advertisements and advertising regions, transaction log history, and the like. This database 252 may also contain other marketing-related information, e.g., frequently requested map areas and click-through rates. The map database 248 may also contain spatial keys, for example quadtree key strings, associating map areas to locations. These spatial keys are used when the RDBMS does not have spatial indexing capabilities.

The map manager 102 generally includes a search module 202, a map module, 204, a layering module 206, and an advertising module 208, according to an embodiment of the invention. The search module 202 generally receives the search requests from users 110, 112, 144 within the GIK system 100 via the network 122. The map module 204 in general generates the map area requested by the user 204, in that it collects the data so that the client device is able to present a map in response to the user's request. The map module 204 generally interfaces with the map database 248 to obtain the specific map information in response to the user's request. The layering module 206 is the module that processes other information that may be displayed as part of the map. This layering module 206, for example, also determines and collects which information, such as advertisers, is to be provided in response to a user's request. This information may include advertisements, contact information for businesses within the map area, reviews—if reviews are part of the GIK system, logos, etc. The advertising module 208 in general handles advertising-related features, functions, and information, such as accepting bids or purchases for advertisement space within the GIK system, process advertiser contact information, update frequency of advertisements, and the like.

Other databases, not shown, may also be present within the GIK system 100. Example databases may include, for example, databases containing geocoding information, state boundaries, zip code boundaries, user ratings, advertisement area boundaries, and the like. In addition, if the GIK system provides other information, such as contact information for business, a database including contact information is maintained within the GIK system 100.

The GIK system 100 may be adapted to handle other features. For example, the GIK system may be incorporated as part of a recommender system, a system that provides reviews by friends and friends of friends, a map searching system, and the like. Modules and databases configured to handle additional features are incorporated as part of the map manager 102.

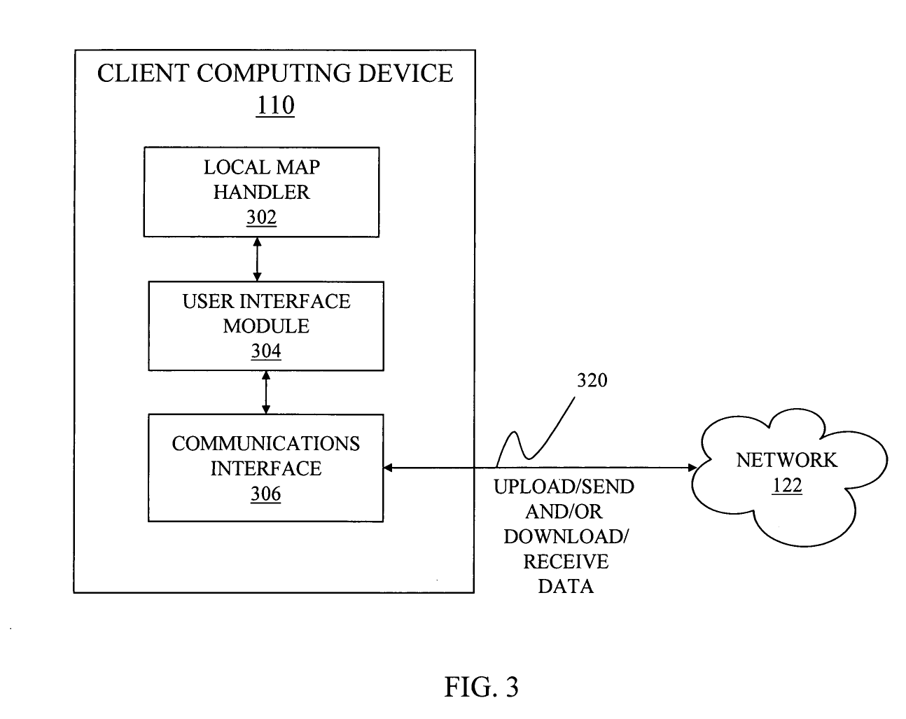

FIG. 3 is a block diagram of an embodiment of a client device 110, 112, 114, 160. In the embodiment, the client computing device 110 is any device that is able to connect to a data network, for example the Internet 122. The client computing device 110 includes a user interface module 304 enabling a user to interface with the GIK system 100, a communications interface 306 enabling a user to communicate 320 with the map manager 102, and a local map handler 302 enabling a user to search using maps.

The user interface module 304 handles the presenting of one or more user interfaces and thereby enabling each user to interface with the GIK system. The presented user interface may be visual or auditory, or even both. For example, a user may enter map search requests via windows or web pages within an Internet browser and enter commands via voice-commands, dual tone multi-frequency signals (DTMF), keyboard entries, touch-screen entries, mouse clicks, and the like. In an embodiment, the user interface 304 is via a web browser.

The local map handler 302 interfacing with the user interface module 304 generally determines if another request is to be sent to the map manager 102. Before a user map search request is sent to the map manager 102, the local map handler 302 first determines if the user's search request may be responded to by information that is currently stored locally, e.g., in memory or in a data store, in the client computing device 110. The client computing device 110 may also include a set of one or more libraries, codes, object libraries, and/or application program interfaces, such as for graphics, maps, and graphical user interfaces, to handle map display, user interaction with the browser or windows, and/or layering of map information. As known to those skilled in the art, this library or codes, may depend on whether the user interface is a browser or windows-based.

The local map handler 302 of an embodiment, instead of requesting an entire map section from the map manager, requests only map differentials/updates, including their associated information. The local map handler 302 and/or the map manager 102 may, in one embodiment, have features enabling load balancing between the user's client computing device and the map manager 102. Information about the capabilities of the client computing device, such as computing speed, hard disk space, and transmission rate is sent to the map manager so that a determination of conditions, such as the amount, type, and/or resolution of data to be transmitted may be determined.

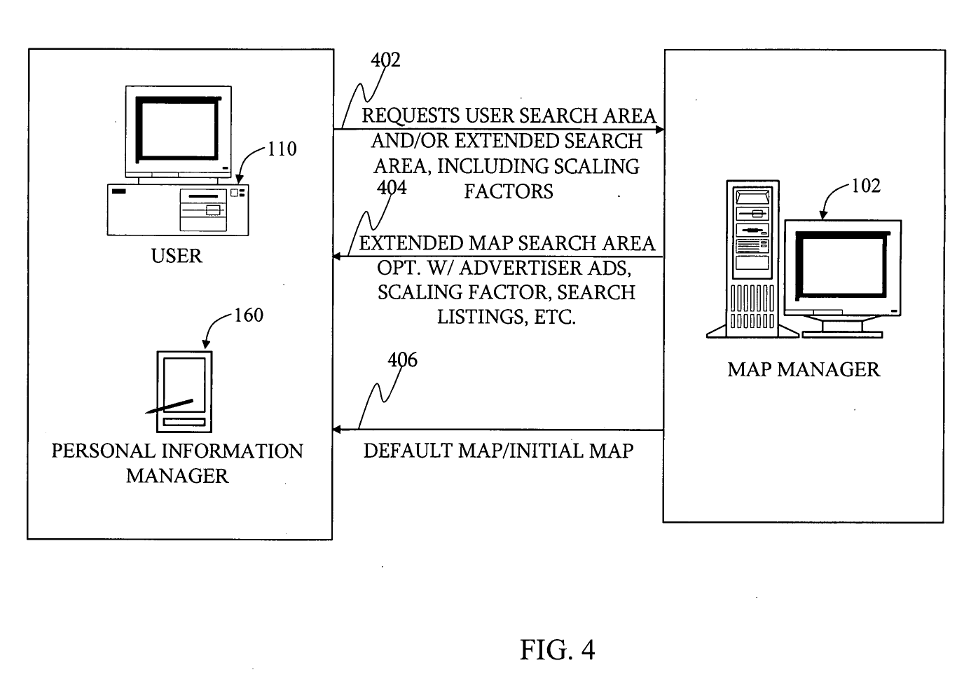

FIG. 4 is a data flow block diagram of how requests of maps are handled within the GIK system, according to an embodiment of the invention. A user search area request 110, 160 is sent 402 to the map manager 102 via a data network. The map manager 102, in response to that request, sends 404 an extended map back to the user. Information sent back to the user 110, 160 may optionally include other information, such as advertising information, reviews, contact information, search result listings, and scaling factor or information that the operators of the GIK system would like to provide to the users of the GIK system. Map scale information is also exchanged between the user client 110, 160 and the map manager 102, so that a proper scaling of the map is presented to the user. In another embodiment, a default/initial map or a map 406 based on certain conditions, e.g., probable location of user, may also be sent to the user by the map manager 102 even without the user initially submitting a search request. Thus, an embodiment of the invention may be used without having users define a search area.

The extended map is generally bigger or wider than the area requested by the user. In one embodiment, the size of the extended search area may depend on one or more attributes, such as: (a) whether the requested area is a commuting area, for example, surveys may indicate that most people in Los Angeles would not mind driving another ten minutes to seek a better restaurant, (b) the number of advertisers that are outside of the user search area, (c) the usual miles people would drive within the area, (d) the scarcity of establishments requested by the user within the search area, (e) the data communication speed between the client device 110 and the map manager 102, and (f) the type of user client device, e.g., wireless. Map updates may also pertain to additional extended map area, for example, if the user is scrolling or searching already within the edge of the requested search area, it is feasible that the user may next request an area particularly outside of the extended area already available. Thus, incremental updates of extended areas may also be provided.

An embodiment of the invention provides a wider or extended search area in response to the user's query. By anticipating or otherwise estimating the user's objective and preparing to support the estimated objective or user's need, the GIK system of the present invention, provides a mechanism where the sending of requests and the responding to these requests are minimized, thus enhancing the speed of response to the user's request. Furthermore, in cases where the user realizes, after storing the resulting user search area in the user's portable wireless device, that the user now needs a wider search area, the user does not at all times need to access the map manager 102 again to get additional information. And, even if the user is unable to access the map manager, the user has additional information more so than originally requested.

The extended map, including other related or, associated information, is stored in a data store, such as volatile or non-volatile memory. The user in one embodiment may also save the extended map under a filename for later retrieval. In one embodiment of the invention, the user may search for information within the user's local device without interactively connecting and interfacing with the map manager.

In addition to the extended map sent back to the user, map-advertising information is also sent back in accordance with an embodiment of the invention. The map-advertising information is a set of information that generally is used by the local map handler 302 to decide which set of advertisements is presented to the user.

There are various mechanisms on how updates to map are sent to the user. In one embodiment, the entire search area map is sent to the user, regardless whether a portion of that map area is already available in the user client computing device. For example, if the user requests the city of Pasadena, the entire map of Pasadena, including an extended area, is sent to the user by the map manager. In another embodiment, only differential map updates are sent to the user, that is, only areas that not available to the user, for example, beyond the extended search area, are sent to the user.

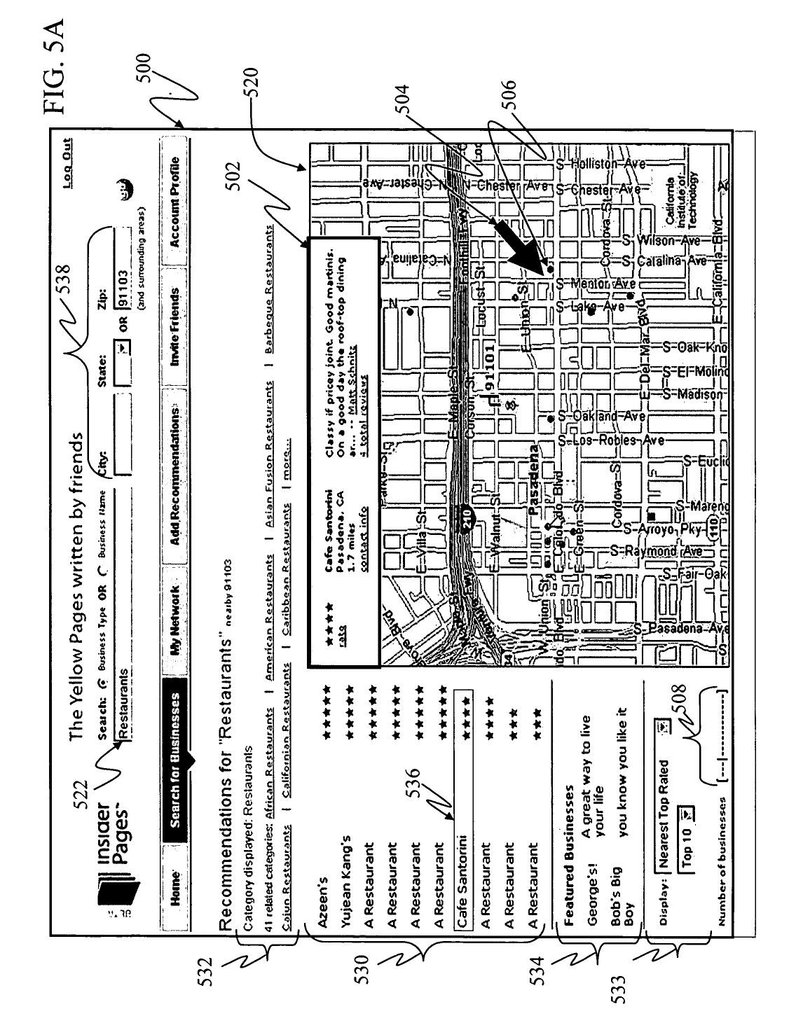

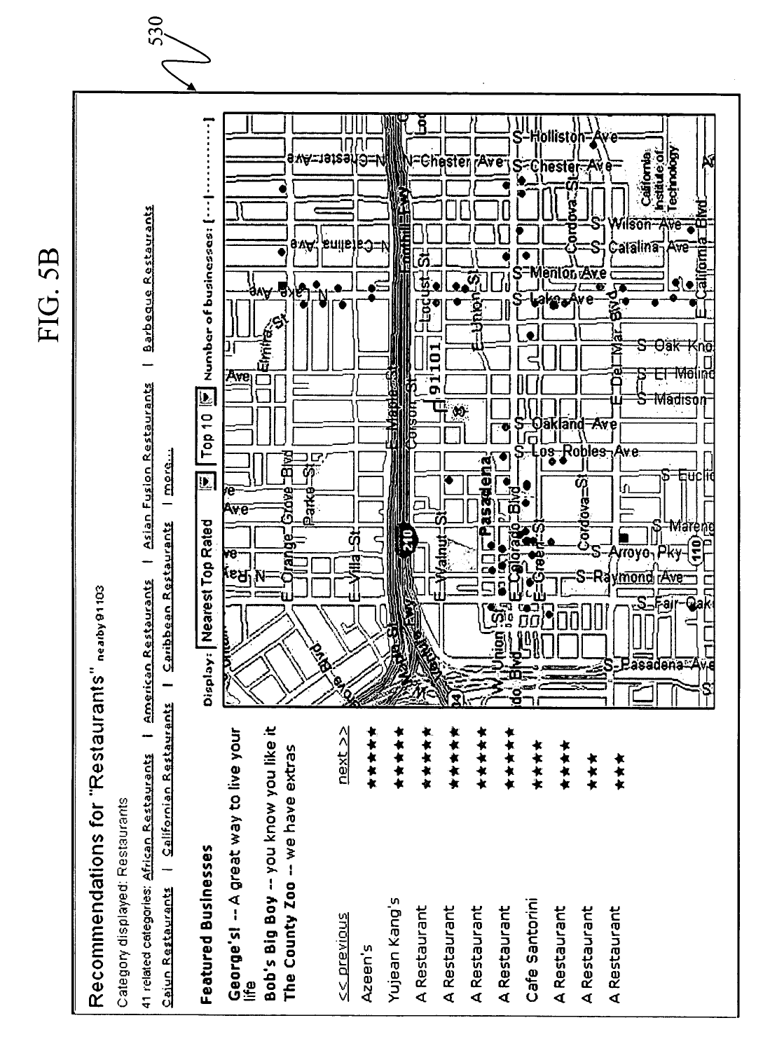

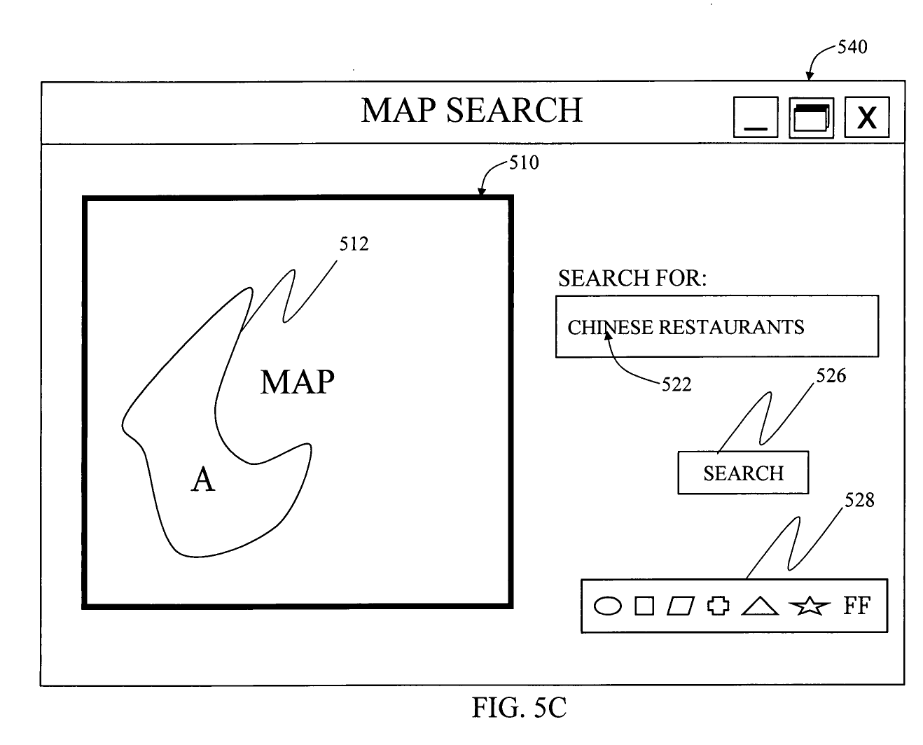

FIG. 5A is an example user interface 500, illustrating for example, a window or a web page on a web browser, according to an embodiment of the invention. Examples of web browsers include MICROSOFT™ Internet Explorer and Firefox from Mozilla. The various features of the user interface are performed by the search module 202, map module 204, layering module 206, and/or advertising module 208 communicating with each other. In one embodiment, the resulting web page displays various sets of information, such as a map area 520, search result listings 530, associated with the map, an inset area 502 for showing more information about a particular entity or search result listing, a featured businesses (advertising) area 534, user interface drop-down list boxes or other elements 508 facilitating user input and selection, and category listings 532.

The map in one embodiment pinpoints, using dots 506 for example, the locations of appropriate entities, for example, “restaurants” 522 as searched and requested by the user. The dots may be configured to be of various colors and/or shapes, wherein the color scheme may indicate additional information, for example, all red dots received a four-stars rating or more, and all paid or featured restaurants are orange. The color-coding of dots is synchronized when displayed in the various display area of the user interface.

In another embodiment, various user interface interactive features are part of the example user interface. For example, a cursor 504 hovering on a dot 506 automatically refreshes the review inset 502 and also appropriately highlights or emphasizes the corresponding side listing 536. A user clicking on the dot 506, in another embodiment, provides another window or frame showing that appropriate profile or more detailed information for that selected entity. A user is also able to click on the inset 502, the list items 530, or other appropriate area of the user interface to obtain additional profile information.

In an embodiment, a user is able to click on the map 520 and drag the map so as to view other map areas. The other appropriate display elements 530, 532,534 of the web page 500 are also updated, depending on the map being displayed. Such update, for example, may occur when the drag is released—i.e., the mouse button is released. The map 520 is presented side-by-side with the associated listings 530, as shown. Various other user interface mechanisms may also be incorporated, such as clicking an area of the map 520 automatically recenters the map based on the clicked area, or moving or placing the cursor near the edge of a map automatically scrolls the map to expose a new map area.

Various other elements or information, such as the recommending friend or friends, may also be incorporated as part of or accessible via the user interface. One element for example is a slider 508 that enables the user to change the number of businesses being displayed. Other user-interaction and/or input mechanisms may also be used, such as manually entering a desired number or having the user select the number of listings to be displayed from a list box 533. A maximum number and minimum number of information, e.g., restaurants, however, are set, e.g., 200 and 10, respectively. The various display elements may also be incorporated in various forms, such as a pop-up window, hover window, or a frame within a frame.

In another embodiment, a user may enter a query by specifying a geographic area, for example, by entering city and state, or zip code 538. Thus, a user may request a search area based on such input information and thus request information entirely or partially outside of the extended search area available. A user may also be conducting searches on the available map information locally available. The searches of an embodiment include for example two box and one box searches, but are not so limited. In a two box search a user inputs “what” and “where”, and “where” can be city, state and/or zip, lat/lon, landmark, airport code, etc. The one box search allows a user to type in a string like “restaurants in Beverly Hills, Calif.

FIG. 5B is another embodiment of an example user interface but having a different layout from FIG. 5A. FIG. 5C is another example user interface 540 wherein the user defines one user search area A 512. In an embodiment of the invention, the user is able to define any freeform shape and/or any geometrically shaped search regions, such as squares, rectangles, ellipses, circles, and triangles. FIG. 5D is another embodiment wherein the user search area consists of more than one search region, e.g., region A 512 and region B 514.

In one embodiment of the invention, the user may define a freeform search region by clicking on pixels or outlining a shape on the presented map 510. The pixels clicked, in one embodiment, are captured and the shape extrapolated based on the pixels clicked. In another embodiment, there is a toolbar 528 presented enabling a user to select which shape the user wants to use to define the user search area.

In the embodiment, a user search area need not be defined. An initial map of a certain size may be presented by having a user enter a certain geographic location, for example, zip code or city name. In another embodiment, a predefined default or initial map is presented to the user, for example, even before the user requests for a particular search area. In another embodiment, the initial map displayed to the user depends on where the user is probably located, which may be determined in a number of ways. In one embodiment, the IP address of the user's computing device, particularly the computer, is requested by the map manager. This IP address is then associated to a certain specific or general location using an IP address look-up database. Examples of companies that provide such a look-up database include IP2LOCATION™ www.ip2location.com, GeoBytes (GeoNetMap product), Akamai, and Digital Element to name a few. In another embodiment, the user's computing device, such as a wireless phone, personal digital assistant, or computer is equipped with its own location tracking or identification system, such as a global positioning system (GPS), which determines the user's probable location by receiving signals beamed down from a satellite array and by using a mathematical process, such as trilateration. In another embodiment, locations based on cell tower information, e.g., cell ID, particularly, for wireless phones may also be used to determine a user's probable location. Other geo-targeting or location-based identification systems may also be used. QUALCOMM™, for example, has gpsOne positioning technology which uses A-GPS, or assisted GPS, a form of location detection in which cell phone towers help GPS satellites determine or locate a cell phone caller's location. SnapTrack's SnapSmart software uses the gpsOne hardware to serve location information to client devices such as cell phones, wireless personal digital assistants, or other wireless instruments.

Maps are generally stored and manipulated using two data structures: raster and vector. As known to those skilled in the art, a raster graphics image in general is a data file structure wherein the image is represented by pixels, meaning the raster image is generally a collection of pixels. Each spatial location or resolution element has a pixel associated where the pixel value indicates the attribute, such as color and elevation. Raster images are generally stored as bitmaps, GIF, and JPEG files. Vector graphics or geometric modeling, on the other hand, uses points, lines, curves, polygons, and the like to represent images. Points, for example, are stored using coordinates, for example, a two-dimensional point is stored as (x, y). Vector maps are generally stored as windows metafile (WMF), EPS, or PDF maps. Other embodiments may offer an image in both formats.

Various map libraries are available from third-party sources. Such map libraries may include maps defined by zip code, counties, states, and the like. ESRI (www.esri.com), for example, is a provider of geographic information systems (GIS) and mapping software applications, and is able to provide map databases and geocoding data. The US Census bureau also has the TIGER/Line Data maps. There are many available providers of map data as known to those of ordinary skill in the art.

Depending on the type or kind of information that is to be displayed as part of the map, geocoding may also be used. Geocoding, in one aspect, is the process of assigning a coordinate (e.g. latitude-longitude) to an address. Geocoding can be according to any number of reference frames (e.g., World Geodetic System references (e.g. WGS 84, EGM 96, etc.), ETRS89, etc). Once the address is assigned to a coordinate, the address may be displayed on a map or used in a spatial search. The process of geocoding is known in the art. Libraries of geocoded information are also available (e.g., Topically Integrated Geographic Encoding and Referencing system® (TIGER®), TIGER/Line®, TIGER®-related products, etc.).

In one embodiment of the invention, the map presented 510 comprises one or more layers to overlay different types of information. Layers may be thought of as transparencies that may be stacked and viewed at one time, or viewed separately. The lowest layer is generally the background map, which is generally visible. Another layer may contain plotting of restaurants, for example, in the area including ratings of friends. Another layer may contain advertisements. Another layer may contain roads, another may contain cities, and another may contain state boundaries. In another embodiment, advertisements are not incorporated as part of another layer, but are handled separately. In one embodiment, advertisements are shown on a different location, e.g., not on top of the map. The various layer data are stored in a database.

Referring to FIGS. 5C and 5D, the user may define the search area via a search definition, meaning by identifying the user search area—search region A 512 and/or search region B 514. In this example GIK system 100, the user is able to search for reviews made by that user's friends. In this user interface 540, the user has also entered the query term “CHINESE RESTAURANT” 522, to limit the businesses to be displayed. After defining the user search area and entering the query term, the user may click on the search button 526 to obtain a result. Various other mechanisms for the user to refine or to conduct searches may also be used.

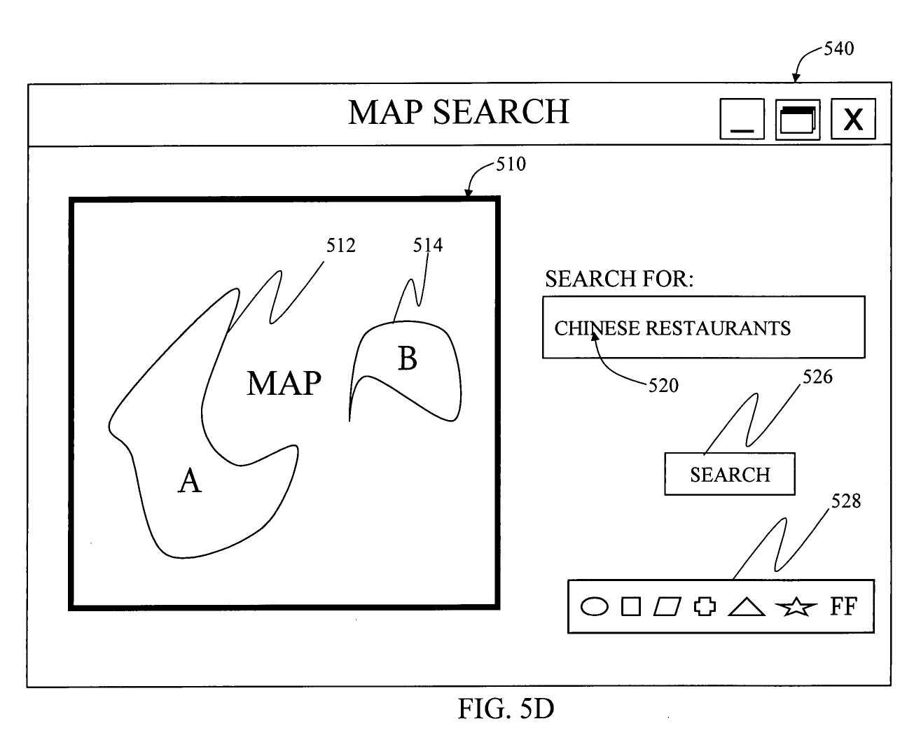

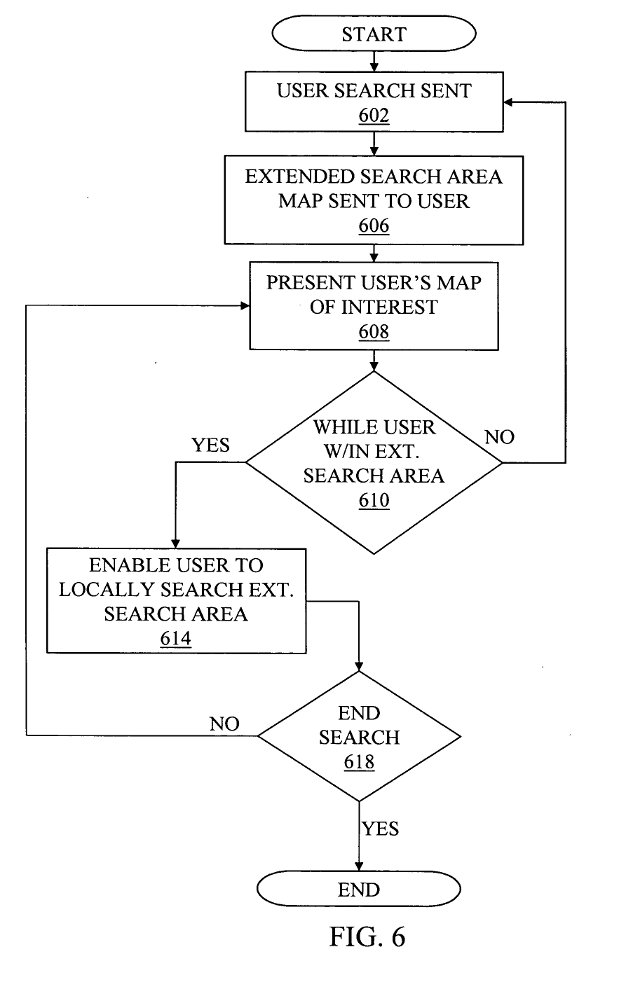

FIG. 6 is a flowchart of an example search, according to an embodiment of the invention. In the first operation, after the user has submitted an initial request, a request is sent to the map manager 102, particularly to the search module 202 to satisfy the user's request (step 602). The search module 202, in conjunction with the map module 204 of an embodiment, the layering module 206, and, optionally, the advertising module 208, returns a resulting extended map in response to the user's query (step 606). The resulting extended search map generally contains information needed to display the user's map area of interest and an additional area outside that user's area of interest, including layers, if any, and also any additional information, such as advertisements, that may be used by the local map handler 302 and/or the user interface module 304 to present the resulting response. The extended map is then used to present to the user, the user's area of interest, meaning the map that the user requested (step 606). Additional map area contained in the extended map, however, is not presented. This way, the display is compatible with the user's request.

The user may continue searching. While the user searches are within the extended map area (step 610), stored locally, the user is able to continue searching without sending an additional request to the map manager 102 (step 614). If the requested search area, however, is outside the extended search area 610, the local map handler 302 communicates with the map manager 102 and sends another user request. The user request sent includes the search area and other user request information, for example, query term, if applicable. The search request may also contain client device-related information, as explained below. In an alternative embodiment, the local map handler 302 requests only updates to augment locally available data. The map manager in turn sends back another extended map or updates in response to the user's query. So in general, the map manager sends back an area larger than the area requested by the user.

The decision of how wide the extended search area to be returned in response to the user search request may be done either in the client device 110, for example, via the local map handler, by the map manager 102, or both. The local map handler, for example, may query the operating system to check for the specifications of the user's client device, such as memory size, data communication speed, free disk space, and the like, to determine the width or dimensions of the extended search area with which to respond In another embodiment, the local map handler 302 has additional features that capture, for example, the frequency with which the user has used the GIK system, the frequency with which the user has searched within the extended search area, and the number of miles in distance the user has ventured from the user's original search request. This information may be captured by the local map handler and stored in a data store, such as a file or in a cookie. Based on these various attributes or on a set of conditions, the local map handler 302 determines the extent or dimensions of the extended search area to request from the map manager.

In another embodiment, these attributes are sent to the map manager along with the user search request, and the map manager determines the size of the extended search area or update area to send back to the user in response to the user's request based on a set of conditions defined within the map manager. These attributes may optionally be stored in the map manager. In another embodiment, the local map handler 302 sends a request for an extended search area which may be fine-tuned by the map manager 102.

If the search is outside the extended search area, another request is sent to the map manager. The map manager accordingly then sends back an extended map search area or updates, thereof. The user may end the search (step 618) at any time if so desired.

In another embodiment, the user may start the local map handler 302 without accessing the map manager 102. In this embodiment, an extended search area or an initial or default area was previously received and was accordingly stored in the client device 110, e.g., user's PDA, computer, etc. The user may conduct searches using the previously stored area or map, without communicating with the map manager. When the user searches outside the extended search area, however, the local map handler then communicates with the map manager to receive an extended search map or updates in response to the user's request.

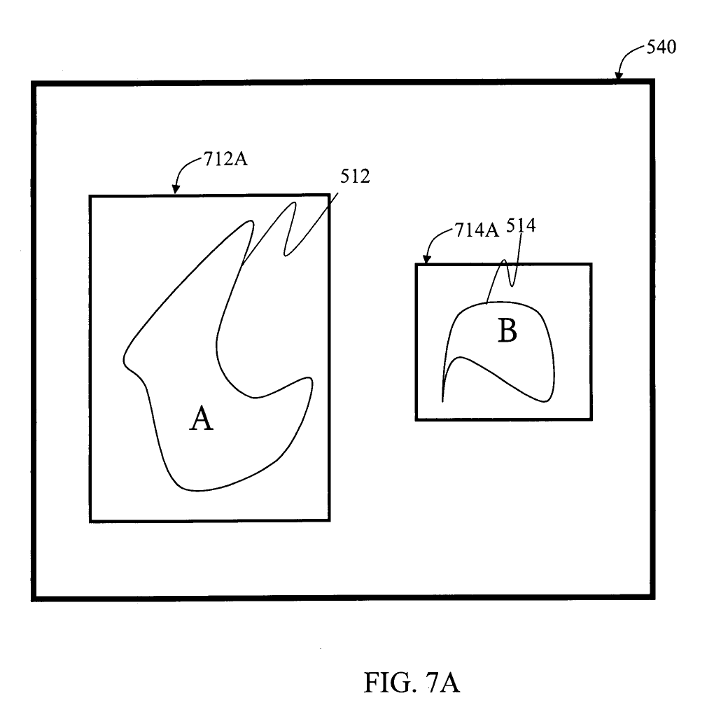

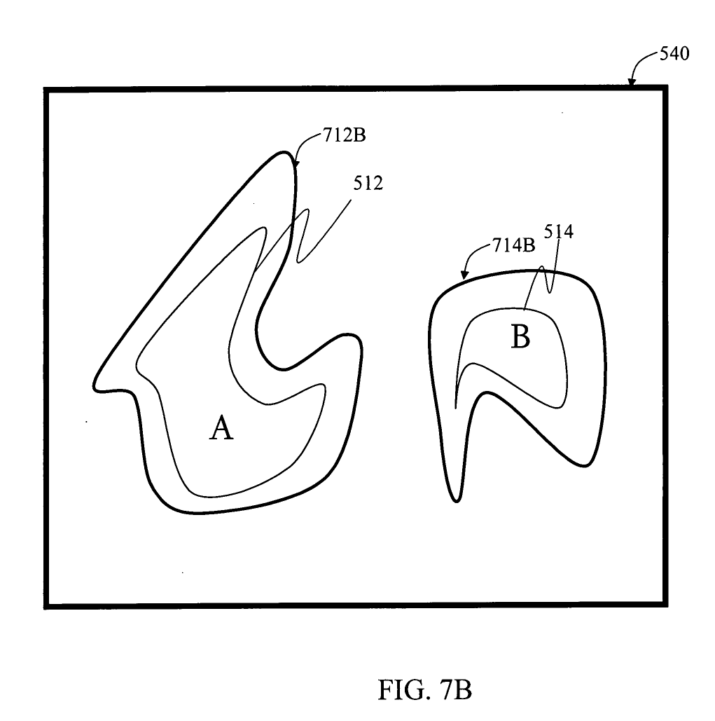

FIGS. 7A and 7B show two example extended search areas or maps 712A, 714A, according to an embodiment of the invention. Referring back to FIGS. 5C and 5D, the user has specified a user search area comprising of two search regions A 512 and B 514. The extended search map sent by the map manager is larger than the user search area and may be of a different shape as shown, i.e., the requested area is of freeform shape and the resulting displayed area is rectangular in shape. Here the example extended search area includes two rectangular extended search regions 712A, 714A. The extended search map may be wider proportionately than the original search area or be wider based on certain size conditions. The shape of the map presented to the user is rectangular in form. Updates and screen refresh, for example, are performed grid by grid, as known to those of ordinary skill in the art.

FIG. 7B shows another example extended search map. The extended search regions “A” 712B and “B” 714B are the same shape as the original user search area. The extended search regions may be extended in a number of ways, for example, 120% bigger than the user search region, 120% wider width and 150% taller height, 20 miles bigger all around the perimeter of the user search area and/or region, etc. Generally the extended search map covers a superset of the entire viewable area but is not so limited.

In one embodiment, regions outside of the user requested area may be blacked out or grayed out. In one embodiment, the resulting map displayed to the user is in the form of one contiguous rectangular form, with areas optionally grayed out, if so desired.

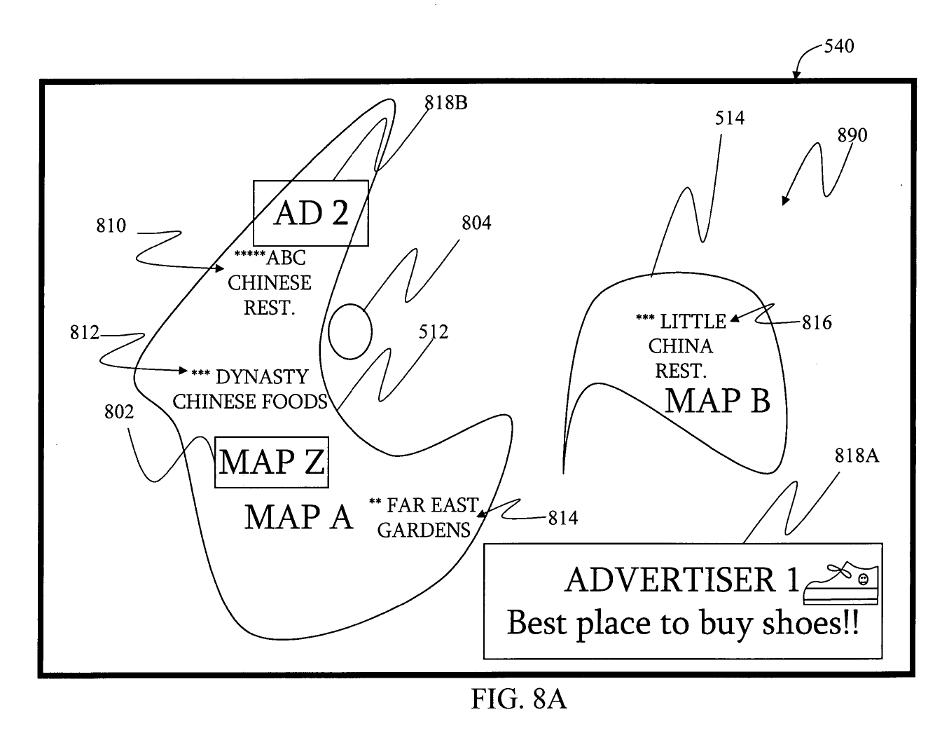

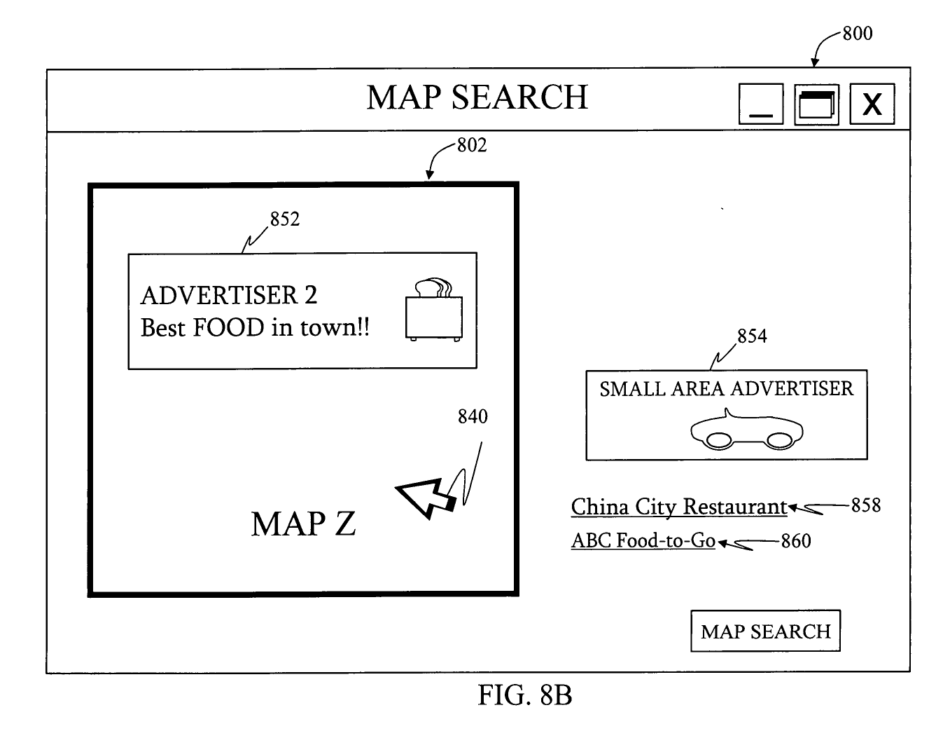

FIG. 8A is another example interface showing the map area 540 of the window or page displayed in FIGS. 5C and 5D. The example extended map area 540 is in response to the query submitted by the user in FIG. 5C. In this embodiment, the GIK system also provides rating or recommendation information. The GIK system also enables a user to browse and/or search the map and place targeted advertising based on the size and what map is being displayed, based on where the cursor is, or based on other conditions defined by an advertising scheme. In this embodiment, users of the system rate restaurants from a scale of one to five stars. In another embodiment of the inventions, the users of the systems have personal networks, wherein each user is connected to direct friends, and indirectly connected to friends of friends. The recommendations are filtered based, for example, of showing recommendations by direct friends, friends of friends, etc. This may be implemented using layers on the map.

In this example extended map, the various Chinese restaurants, in response to the users' request, are plotted on top of the map, for example, using geocoding. The recommendations/ratings are sent as part of the search map, so that information provided by the GIK system may be accordingly presented to the user. The ratings 810, 812, 814, 816, including the restaurants' names, may be stored and/or represented as another layer in the map, which may be in turn, is stored on a database. Based on advertising conditions related to the search area, one or more advertisements 818A, 818B are displayed, for example, on top or above 818B of the map. The ads may also be placed at other locations within the user interface.

In one embodiment of the invention (not shown), separate search regions are presented one at a time. In this example presentation, the two separate search regions 512, 514 are presented together. In one embodiment of the invention, only the search region requested by the user is displayed, while the outside area 890, even those within the extended search map, is blacked or grayed out or in another color scheme as the user's search area. Variations of how the user search area is distinguished from the area outside of the user's search area are known to the art.

In this embodiment, should the user wish to request another search area shown by the search area MAP Z 802, the user may do so, for example, by drawing a rectangular box. The user's area of interest, which is Map Z (FIG. 8B), is then accordingly presented. In this embodiment, a request to the map manager need not be initiated because data has been previously provided to the client computing device.

If the user's search area is outside the original user's area of interest, for example, an elliptical region 804, the local map handler may satisfy that request with information that the local map handler obtained when the extended map was sent to the user. Only when the elliptical search region 804 is outside the extended map sent to the user will the local map handler make a request to the map manager 102.

FIG. 8B is another example user interface 800 showing another embodiment of the invention. This example interface, for example, may be the result of the user requesting a MAP Z search area 802, as shown in FIG. 8A. In this embodiment, the location of the cursor 840 influences for example, the hyperlink advertisements 858, 860 presented. Movement of the cursor results in a different set of advertisements being displayed. The size of the advertisements 852, 854, 858, 860, when and how often presented, may be part of the advertising conditions that the user has purchased or has placed a bid or value on. The size of the map 802 currently being displayed may also dictate the advertisements that may be presented to the users. Various types of advertisements may be shown in various formats and media, such as text, graphics, combination, sound files, video clips, etc. An advertisement is any set of information that may be provided to the user. It may include conventional advertising information, such as images and text promoting certain products and/or services, but it may also include non-advertising information, such as public domain information, e.g., portions of the bible, and prepared information, e.g., “Today is Secretary's Day.”

The advertisements 852, 854 may also be dynamic advertisements, such as being animated to the extent of moving across the web page or moving above the map. Variations of advertisement media, such as video ads and even just audio ads, may be incorporated herein.

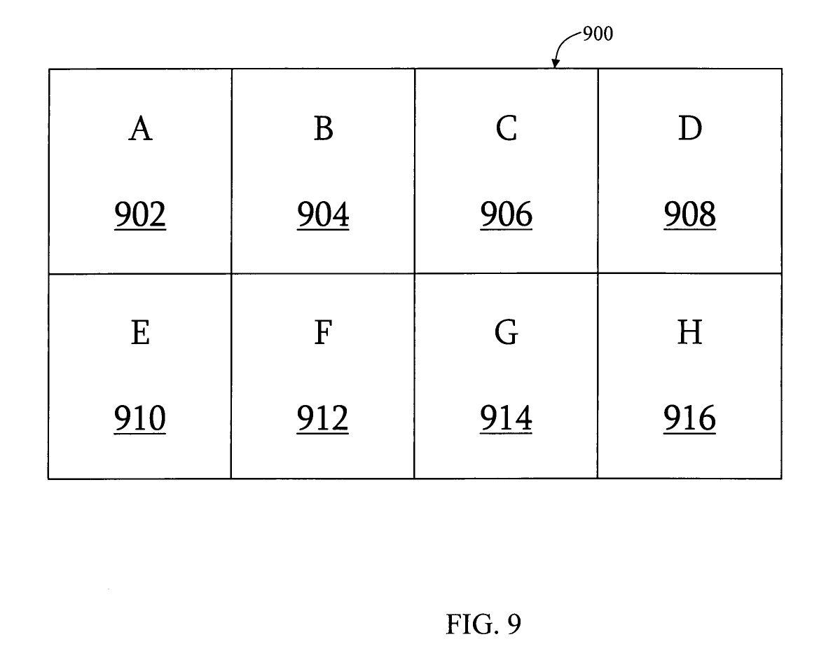

FIG. 9 is an illustration of an example manner in which a map may be divided into various sections for advertising purposes. In this embodiment, a map 900 is divided into various advertising regions A 902, B 904, C 906, D 908, E 910, F 912, G 914, and H 916. Each of these advertising regions may be allocated to or associated with one or more advertisers, such that when the particular advertising region is presented, the one or more advertisements by the associated advertiser are accordingly presented. In one embodiment, an advertising region is only associated with the highest ad bidder, that is, only the highest bidder's ad is displayed to the user.

One or more of these advertising regions may be combined to form another set of advertising regions. For example, regions A 902 and B 904 may be combined to form another advertising region A′B′ that may be purchased by another advertiser, for example, Advertiser X. Such that when region A 902 and region B 904 are both presented to the user, the ads for Advertiser X are presented, the ads of the advertisers associated with region A 902 and region 904 individually may or may not be shown.

The map 900 may further be divided into other portions, with varying sizes and shapes, such as based on county lines, cities, zip codes, pixels, etc. Depending on the advertising section or sections purchased by the advertiser, the advertiser's ad or ads are accordingly presented. In general, the advertising scheme defines how advertisements are presented. The advertising scheme of the present invention does not rely on whether the advertiser is physically located in that advertising region or not. This advertising scheme defines the advertising conditions, such as what advertisements are going to be presented, the manner and frequency with which they are to be presented, when they are going to be presented, the size of the advertisements, and the types of advertisements. In one embodiment, the advertising scheme is based on the map currently being displayed to the user and/or the highest-bidding advertiser or advertisement. Bidding may be done in many ways, such as advertisers may bid on the advertising scheme of their choice from, for example, a list of available advertising schemes or advertisers may define their own advertising scheme based on certain conditions that are provided, for example, a flashing advertisement is $0.05 extra per impression or display. In one embodiment, the advertising conditions are affected by the amount of bid, for example, the highest bidder—for coordinate x, y and within a three mile surrounding perimeter—which can be implemented to override all advertisements and thus is allotted the premium ad conditions.

For example, if a user is presented with the entire map of the United States, the highest bidder or subscriber for that advertising space, i.e., for the entire U.S., for example, Wal-Mart™, is also presented to the user. In another embodiment, an advertiser may also specify a particular region, including a point, in the map, such that if the map being presented to the user contains that region, that advertiser's advertisement is presented to the user. The advertisement may be static, meaning, displayed in just one area, or may be a dynamically moving advertisement, for example, moving from left to right. If the user is presented with a map showing the entire state of California, the ad or ads associated with the highest-bidder for that advertising region, i.e., the entire state of California, are accordingly presented based on the advertising scheme. If the user zooms down to whatever scale in the map, the high-bidding ads within that region is accordingly displayed. As the user moves around the map, via searches or cursor movement, the highest-bidding ads are accordingly presented. So, there are many variations of how the advertising scheme may be defined, for example: the size of the map being displayed or presented defines the ads to be displayed, the advertising spaces displayed define the ads to be presented, and the cursor location defines the ads to be displayed.

In one embodiment, the advertising scheme uses an auction-style bidding system, such that the highest bidder obtains the advertising region or space. In another embodiment, all advertisers who placed a bid for a certain advertising space may all be shown with varying size ads and placement of ads. In the embodiment, the map being displayed to the user dictates whether certain ads are going to be displayed; that is, the advertising regions are regions or pixels that are associated with the map.

In one advertising scheme, the location of the user, for example, based on the user's internet protocol (IP) address or GPS location may also dictate the ad to be displayed. There are mechanisms or databases presently available that may deduce the general location of the user or at least the Internet Service Provider's (ISP) location based on the ISP. For example, if the entire state of California is requested by a user whose IP address is associated with a California Internet Service Provider (ISP), the advertisement shown for the entire map of California would be a Wal-Mart ad, while if the user is associated with an ISP in Arizona, the advertisement that is presented, for example, would be SEARS™. The GIK system is configured to handle various and multiple advertising schemes.

Information relating to these advertising schemes, as well as advertisements and advertisers, are stored in the map advertisers 246 database and/or in other database, such as the advertisers database 242. The ad tracking 252 may be used to track, for example, the frequency with which the ads are sent to users, which map areas are frequently requested, and those states or cities in the U.S. popularly use the GIK system. The finer details of the advertisements, for example, frequency with which a particular advertisement is actually presented to the user, may be captured by the local map handler 302 in the user's client device.

If information about the user or searching user may be deduced or obtained, e.g., demographic or location information, advertisements may also be tailored to such user. For example, if the user is potentially located in Beverly Hills, a Rodeo Drive ad is displayed rather than a Wal-Mart ad, even if, for example, the Wal-Mart advertiser is the highest bidder. So the GIK system of the present invention not only tailors its advertising conditions based on the advertising scheme selected, bid on, or purchased by the advertiser, but also, if applicable, based on user-related conditions and/or attributes (i.e. metadata or history).

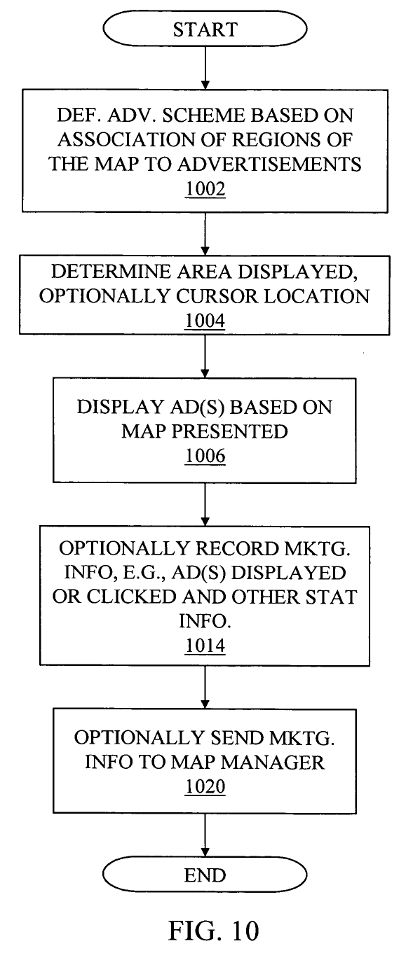

FIG. 10 is an example flowchart of a method by which the advertising feature of the present invention is provided, according to an embodiment of the invention. In the first operation, an advertising scheme is defined which is based on the association of advertising regions of a map to advertisements (step 1002). Next, the map presented to the user and, optionally, the cursor position, (step 1004) is used to determine the one or more advertisements to be displayed or presented to the user (step 1006). Marketing-related information, such as the advertisements presented and whether there was a click through, and other information are captured and stored (step 1014). This is captured on the client device 110 and alternatively also sent to the map manager 102 (step 1020). This marketing-related information may be used to help in soliciting more advertising revenues or to tailor the advertising scheme to obtain a better stream of revenue.

Thus, in this embodiment of the invention, information sent back to the user includes the extended map search area and optionally map-advertising information, which is used by the local map handler 302 to determine which advertisements are to be displayed.

In one embodiment, advertisers also interface with the map manager to define and subscribe, e.g., bid or purchase, advertising schemes. This interaction is via a web site dynamically presented by a web server, and incorporated as part of the map manager. An embodiment supports advertising “feeds” that are pulled from the advertiser server.

There are many ways to implement the features of the present invention. In an embodiment, the client-server architecture of the present invention, involves a client piece, for example a web browser and a server piece, implemented as a web server, dynamically serving web pages to the web browser. In another embodiment, the client piece is a stand-alone set of program instructions, such as software, interactively exchanging data with the map manager, for example, via data structures such as extensible markup language (XML) files. The stand-alone set of program instructions executable by a computing device may be written in various programming languages such as C, C++, and Visual Basic. The web browser may also include browser plug-ins and other add-in features (i.e. AJAX-type interaction).

The processing of the advertising schemes may be implemented in various ways. For example, some processing may be done at the map manager side, while some processing may also be done at the client side. For example, the user's computing device may also have a function that retrieves the user's current location, for example, via GPS positioning and based on that interactive or current information, retrieve the appropriate advertisement from its local memory or interactively request another set of advertisements from the map manager. One skilled in the art will appreciate the various embodiment of how the features of the present invention may be implemented.

Quad-Tree Indexing:

One feature of the present invention enables quick searches and viewing of maps, for example the map of the entire world. This is generally facilitated by spatial indexing. To perform such feature, databases that have spatial indexing may be used to facilitate efficient and quick retrieval of maps and even the associated layer information, e.g., advertisement information, review information, and businesses and their locations on the map. An example of such database is ORACLE™ Spatial, an option to ORACLE 9i Enterprise edition.

In another embodiment, spatial indexing is performed by using a spatial text key, in conjunction, with a database that performs conventional text indexing, but not spatial indexing. By using the spatial key of the present invention, databases (or text search engines such as Verity or Lucene) that have a regular text indexer may also be used to perform the features of the present invention. In this embodiment, the map of the earth is divided into multiple quadrants or regions to facilitate indexing of spatial information and to easily determine map locations. The map is also displayed as raster graphics, so that, differential updates may be performed.

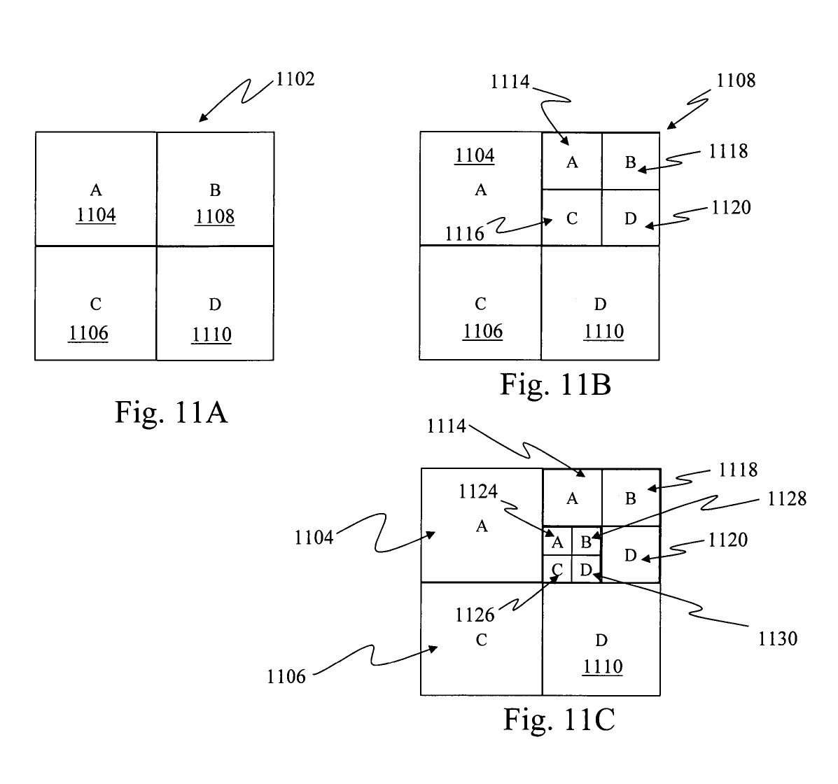

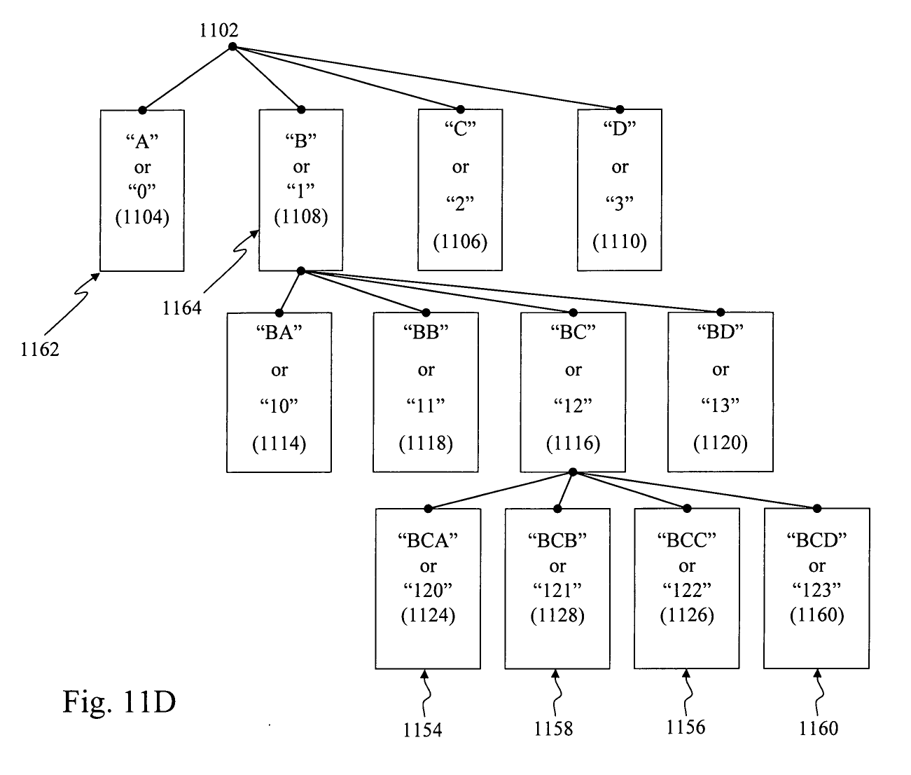

FIGS. 11A through 11D show how an area may be subdivided into sub-areas/regions/quadrants and each region represented by an associated spatial key. FIG. 11A, for example, shows how a map 1102 is represented using quadrants. The map is divided into four quadrants: A 1104, B 1108, C 1106, and D 1110. The area represented by quadrant B 1108 is further subdivided into additional four quadrants: A 1114, B 1118, C 1116, and D 1120, as shown in FIG. 11B. Quadrant C 1116 is further subdivided into additional quadrants: A 1124, B 1128, C 1126, and D 1130, as shown in FIG. 11C. The number of times the map is subdivided into various quadrants may depend on various factors, including, how much detail or resolution is needed and/or data processing speed. Although the quadrants are represented as “A,” “B,” “C,” and “D” other representations may also be used such as “0,” “1,” “2,” and “3” and other alphanumeric or symbolic representations and variations thereof.

FIG. 11D shows how the various quadrants are indexed using spatial keys and are represented as nodes of a tree, for example a quad tree. This figure also shows the spatial indices, if the quadrants are represented by the numbers “0” through “3,” instead of “A” through “C.” Thus, the quadrants A 1124, B 1128, C 1126, and D 1130 are represented by indices “BCA” or “120” 1154, “BCB” or “121” 1156, “BCC” or “122” 1156, and “BCD” or “123” 1160, respectively. Tree searching and indexing, such as those techniques using recursion, are known to those of ordinary skill in the art.

In general, larger regions or areas are expressed by shorter spatial key strings, e.g., the biggest quadrant A 1104 is represented by the spatial key “A” or “0” 1162, while the smallest quadrant A 1124 is represented by the spatial key “BCA” or “120” 1154. Quadrant B 1108, for example, represented by spatial index “B” or “1” 1164 thus also contains quadrants A 1114, B 1118, D 1120, and C 1116—A 1124, B 1128, C 1126, and D 1130. Using this process, a map may be divided into as many granular sizes or resolutions as desired, to facilitate map searching and indexing. The hierarchical depth of an embodiment of a tree of the present invention is also related to the length of the spatial key string. Furthermore, spatial keys with a common prefix belong to the same quadrant, for example, quadrants A 1124 with key “BCA,” B 1128 with key “BCB,” C 1126 with key “BCC,” and D 1130 with key “BCD” all have the same common prefix, i.e., “BC” and belongs to the same quadrant C 1116; while quadrants A 1114 with key “BA,” B 1118 with key “BB,” C 1116 with key “BC,” and D 1120 with key “BD” have the same common prefix “B” and belong to the same quadrant B 1108.

With the areas of the map indexed using the spatial keys of the present invention, queries may easily be done by just using substring queries on the spatial keys. The queries include for example substring queries and prefix substring queries, which usually match very well with either b-tree indexing schemes or prefix-indexing in text index engines. Furthermore, although the example spatial key is described using a quad tree, other n-trees may also be used—where n is the number of subdivision per area. For example, 16-trees (hexadecimal), 9-trees (base-9), or 3-trees (base-3) may also be used. Other types of hierarchical spatial structures such as binary space partitioning (BSP) trees or KD trees may also be used. A KD tree is generally a multidimensional search tree for points in k dimensional space, wherein the levels of the tree are split along successive dimensions at the points. KD trees, BSP trees, N-trees, and the like are known to those of ordinary skill in the art. The trees of the present invention may also be adapted to process multi-dimensional or n-dimensional spaces (e.g., 3-dimensional spaces) via, for example, octrees.

Using the spatial indexing described above, the spatial text indexing may be associated with particular coordinates, for example, latitude and longitude, locations, addresses, and regions. This may be manually assigned or assigned automatically via a set of program instructions, for example, software executable in a computing device. Such processes are exemplified below:

### EXAMPLE 1

### Assigning Spatial Index Keys and Searching for all Geocoded Addresses (Points) within a Complex Region

1. Determine the coordinates, e.g., latitude (lat) and longitude (lon) of the address or point within the map and convert each coordinate to binary form. Each coordinate is converted into binary form, each with the same number of digits. Negative numbers are expressed in two's (2's) complement.

For example, assume that lat/lon coordinates for Arcadia, Calif. (assume that the binary form contains 9 digits, first digit contains the sign, i.e., positive or negative, and the rest of the digits contain the value):

Lat = 34.25 = 000100010.0100 binary
Lon = −118.0 = 110001010.0000 binary

2. Interleave the bits of the lat and lon, so that the first bit of lat is before the first bit of lon, the second bit of lat is before the second bit of lon, and so on. (Placing the lon bit before the lat bit would also work.)

3. Group the interleaved bits by twos—meaning group the first and second bits, third and fourth bits, and so on.

4. Convert the groups into a number using base-4 and combine all the base-4 digits together. This resulting number is the quadtree string or the spatial key associated with each region or coordinate.

Continuation of Example:

Interleave the bits and separate into groups of 2 (steps 2 to 4):

01 01 00 10 00 01 00 11 00 00 10 00 00 becomes 1102010300200 which is the quadtree string/spatial key.

Searching:

For illustrative purposes, assuming that there are millions of addresses within a particular area where the search is of a complex region defined by areas or quadrants C 1106, B 1108, and C 1116. (More complex regions may be handled, for example, by having areas defined with more details or resolution.)

A search following the example steps provided below may be performed:

1. Load the database/text indexer with the various addresses along with their quadtree strings/spatial keys associated with their lat/lon positions. Thus, one or more quadtree strings/spatial keys are associated with the appropriate address records. The quadtree strings/spatial keys are loaded in a separate table, so that there is no search overlap with the addresses or any other metadata.

2. Search the quadtree strings or spatial keys for keys beginning with “C” or “BCC” or “BB,”—for example, a search string query for “C*” or “BCC*” or “BB*”. (The example search, for example, may be performed using standard query language (SQL) and/or stored procedures.)

3. The result of the substring query in step two would contain those keys within quadrants C 1106, B 1108, and C 1116. Using these keys, the appropriate address records may also be retrieved accordingly.

In an embodiment, one or more quadtree strings or spatial keys are associated with an address or location record, with each spatial key representing a quadtree region. The database, for example, RDBMS, may be normalized via first normal form, so the quadtree strings/spatial keys are stored in a separate table associated with the complex region table. For example, one or more spatial keys may be associated with a complex region, such as a neighborhood or zip code. The spatial keys or quadtree strings described above may also be associated with advertising regions, for example, shown in FIG. 9. Complex advertising regions may also be associated to one or more spatial keys.

### EXAMPLE 2

### Find all Regions that Intersect a Given Complex Region

To find all regions that intersect a selected complex region, for example, one defined by quadrants C 1106, B 1108, and C 1116, the example steps below may be performed:

1. Generate all possible substrings or spatial keys of the selected complex region. For our example, the spatial keys or substrings are C, B, BC, BCC, B, and BB.

2. Remove duplicate strings. Result—B, BB, BC, BCC, and C.

3. Search for these strings, plus strings with prefixes belonging to the originally selected complex region. For example, search for “B” or “BB*” or “BC” or “BCC” or “C*.”

4. Returned would be all complex regions that intersect our complex region.

### EXAMPLE 3

### Find all Regions that are Completely Contained in a Selected Complex Region, for Example, Defined by Quadrants C 1106, B 1108, and C 1116

1. Do a prefix search of the selected complex region, in this example, using a search string query “C*” or “BCC*” or “BB*.”

2. The resulting list would contain all the set of quadtree strings/spatial keys for that selected region defined within the database. (This is a generalized case of Example 1 above.)

### EXAMPLE 4

### Find all Regions that are Outside of a Selected Complex Region, for Example, Defined by Quadrants C 1106, B 1108, and C 1116

Two Example Ways:

A. Do a “NOT” search on the spatial keys, that is find all regions that do not have spatial keys starting with “C”, “BCC,” or “BB”—NOT “C*” and “BCC*” and “BB*.”

B. Invert the quadtree and do a contain search on the selected complex region as exemplified in Example 3. For the example selected region, inverting the tree would result in obtaining “A”, “D”, “BA”, “BD”, “BCA”, “BCB”, and “BCD.” This is done by performing a search with “A*” or “D*” or “BA*” or “BD*” or “BCA*” or “BCB*” or “BCD*,” which would find all regions that are completely contained within these regions but outside of the selected complex region.

Converting areas, including complex areas, into a hierarchical representation, such as a quadtree, may be performed using conventional recursive algorithms. For example, to convert a circle into a quadtree that most accurately or to a particular resolution surrounds the circle, an algorithm similar to the one below may be used:

```
generateQuadtree(nodeSquare, circle)
{
  /* only exclude a nodeSquare if it is outside the circle */
  if (nodeSquare outside of circle)
      return
    if (nodeSquare in circle)
      add nodeSquare to list
      return
    /* at this point the nodeSquare is either intersecting or enveloping the
circle */
    if (nodeSquare is small enough)
      add nodeSquare to list
      return
    generateQuadtree(nwQuadrant(nodeSquare), circle)
    generateQuadtree(swQuadrant(nodeSquare), circle)
    generateQuadtree(neQuadrant(nodeSquare), circle)
    generateQuadtree(seQuadrant(nodeSquare), circle)
  }
  This would be called with the root nodeSquare at first.
  To generate a quadtree that most accurately is inscribed within a circle:
  generateQuadtree(nodeSquare, circle)
  {
    /* only add to the list of the nodeSquare is actually inside the circle */
    if (nodeSquare in circle)
      add nodeSquare to list
      return
    if (nodeSquare outside of circle)
      return
    if (nodeSquare is small enough)
      return
    /* at this point the nodeSquare is either intersecting or enveloping the
circle */
    generateQuadtree(nwQuadrant(nodeSquare), circle)
    generateQuadtree(swQuadrant(nodeSquare), circle)
    generateQuadtree(neQuadrant(nodeSquare), circle)
    generateQuadtree(seQuadrant(nodeSquare), circle)
  }
```

The above example is an example algorithm, which can be adapted to covert various complex areas into n-trees, e.g., quadtrees, or to other hierarchical representations.

In one embodiment, the lat and lon coordinates may be stored in separate tables or databases. For example, a string search for “34*” and “−118*” (example Arcadia, Calif. coordinate) may be performed to find all records with regions within the box of 34.0<=latitude <35.0, −118.0>=longitude >=−119.0 longitude.

Other features of the inventions are disclosed in the attached Appendix A and B, both appendices are herein incorporated by reference.

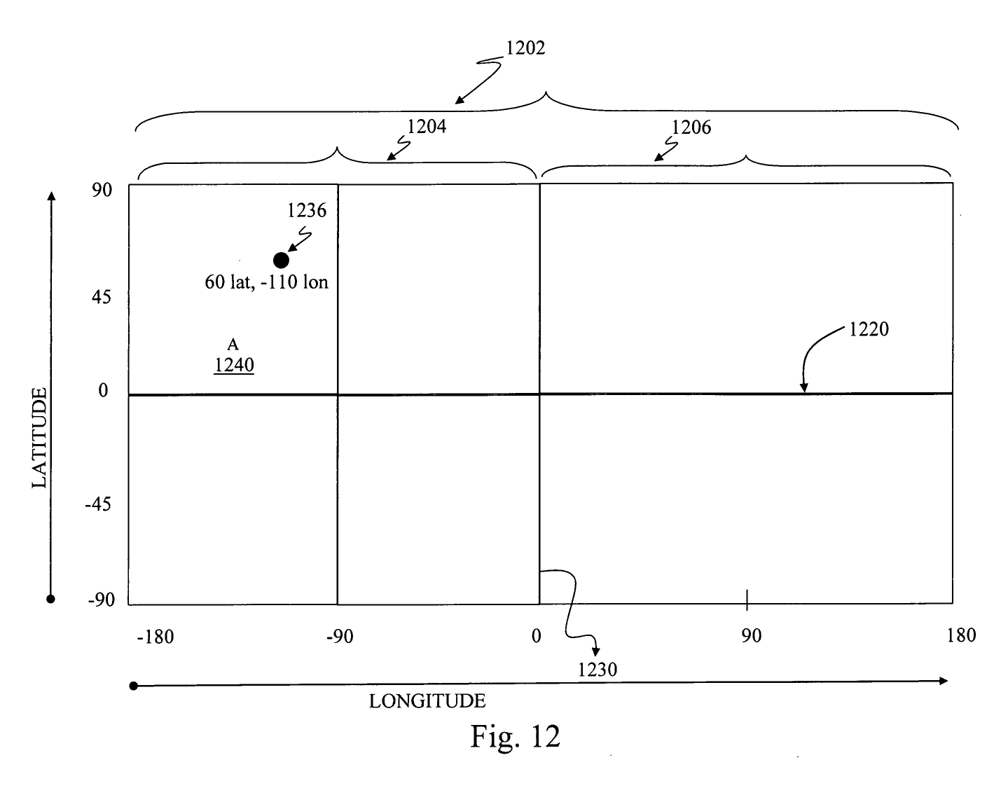

FIG. 12 is a graphical representation of another example map 1202. This map is divided into two hemispheres, the left hemisphere 1204 and the right hemisphere 1206. This figure shows how the spatial keys described herein can be used to associate areas, locations, addresses, and the like to coordinates such as latitude and longitude. This figure acts like an X and Y axis, where the horizontal line 1220 shows zero latitude, while the vertical line 1230 shows zero longitude. Thus, a map of the world may be superimposed or associated with the spatial indexing of the present invention. For example, quadrant A is defined within an area bounded by 0 lat/−180 lon, 90 lat/−180 lon, 0 lat/−90 lon, and 90 lat/−90 lon. An address or location 1236 with example coordinate (not drawn to scale) 60 lat/−110 lon, for example, may be identified by a spatial key of the present invention, by just further subdividing quadrant A 1240 to a resolution or area size so that that location 1236 may appropriately be identified by a corresponding spatial key, for example “ABCBABCD”.

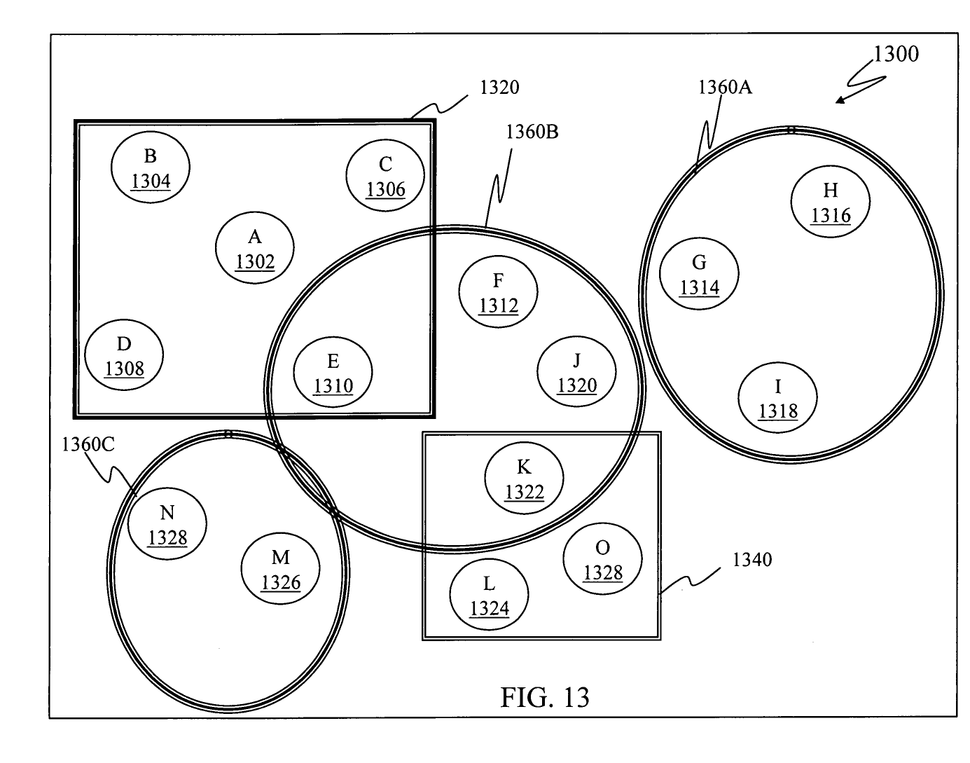

FIG. 13 is a graphical illustration of a user network 1300 comprising a plurality of users implemented in the GIK system 100 that may be implemented in accordance with another embodiment of the invention. The GIK system 100 in this embodiment also functions as a recommendation system as exemplified in FIG. 8A. The users, however, in this user network 1300 includes a number of affinity network types 1320, 1340, 1360A-C. Each affinity network may have one or more affiliates. The affiliates within each affinity network generally have relationships with each other. Furthermore, this relationship is defined by or includes multiple varying attributes, including, for example, affinity/relationship weight.

In another embodiment, relationships are automatically established, for example, by specifying the zip code of the user's residence. Various other criteria to establish or sever a relationship or affinity may also be implemented, such as being automatically created if the gender is male and is single, automatically severed when the relationship weight is less than a certain value, and automatically created when the recommending patterns of the two users are similarly alike as decided, for example, by a collaborative filtering algorithm. This example embodiment of creating an affinity network may apply to various types of affinity networks, such as familial affinity networks, contact connection affinity networks, common interest networks, etc.

Examples of affinity network types include, but are not limited to:
a) affinity by familial relationship (familial affinity network), e.g., wherein affiliates define themselves as members of a family network related by blood, marriage, or just by mere closeness of their relationship with each other;
b) affinity by common interest (common interest affinity network), i.e., an affinity network based on common interest, e.g., Pasadena Moms Group, San Fernando Valley Harley Davidson Bikers group, and Southern California Auction Seller Group;
c) affinity by geographical location (location affinity network), e.g., an affinity network based on geographical location and the relationship/affinity weight is dependent on how close in distance an affiliate is to another affiliate;
d) affinity by personal knowledge (who-you-know or contact connection affinity network), e.g., an affinity network is defined by who you know, and how you indirectly know other people;
e) affinity by profession (profession affinity network), i.e., an affinity network based on a user's profession, e.g., doctors, lawyers, accountants, etc.; and
f) affinity defined by user similarity (similarity affinity network), e.g., an affinity network based on how similar the users are, such as their likes and dislikes etc., defined by a process such as collaborative filtering.

Other affinity networks may include affinity based on age, income, demographics, gender, and age group. One skilled in the art will realize that various other types of affinity networks may be created and be within the scope of the present invention.

In one simple embodiment, the GIK system 100 has only one type of affinity network type, i.e., the contact connection affinity network type, wherein a network is defined based on who the user directly knows, and the user indirectly knows from a friend of a friend, and so on. In one variation, the relationship between two users is based on one attribute. In another variation, the relationship is based on a plurality of attributes. In a more complex embodiment, the GIK system 100 has a user network 1300 with two or more affinity network types. The relationship may be based on one or more attributes.

Within the user network 1300, there may be a number of affinity networks of the same type, such as there could be a number of familial affinity network, e.g., one familial affinity network for those family members related to John J. Smith, another for those related to Mei Tan, another for those related to Michael R. Jackson, etc. Furthermore, the GIK system 100 is also adapted to manage affinity networks of varying types, e.g., a familial affinity network related to John J. Smith and a contact connection affinity network, such as friends of Peter J. Carter.

There are a number of ways a user may become part of a particular affinity network, such as a user may elect to join an affinity network; be automatically assigned to one; be invited to join and accordingly accept an invitation, etc. By way of example, these user relationships/affinities may be defined, for example, by mutual agreement between users, e.g., acceptance of invitations and/or by automatic generation of data sharing relationships, for example, by just being an affiliate within a personal affinity network. In addition to being an affiliate of a particular affinity network, users in some embodiments may assign the relationship weight between their affiliates and/or have the relationship weight automatically be adjusted by the GIK system 100. This relationship weight influences or alters the way the original recommendations and/or feedbacks are presented to the user, for example, a rating of five stars is displayed as three stars because the recommendation was influenced by the relationship weight. In another embodiment, the relationship weight may alter how information is displayed, such as the order of presentation of recommendations.

Referring back to FIG. 13, this shows three example affinity networks, 1320, 1340, and 1360A-C. The first affinity network 1320 (top-left corner) is based on who the user knows, i.e., a contact connection affinity network. This affinity network shows that User A 1302, User B 1304, User C 1306, User D 1308, and User E 1310 directly or indirectly know each other. The second affinity network 1360A-C is an affinity network based on familial relationship—familial affinity network. For example, Users N 1328, M 1326, E 1310, F 1312, J 1320, K 1322, G 1314, H 1316, and 11318 are related by blood, marriage, or by closeness to each other that they have decided that they are “family.” The third affinity network 1340 is based on geographical location, e.g., zip code where the user resides. In one embodiment, there are a number of geographical or location affinity networks such that these affinity networks encompass the entire user network 100. Furthermore, the closer in distance the user is with the other user, the greater the relationship weight between these two users.

As illustrated, a user may be an affiliate of one or more affinity networks. For example, User E 1310 is a member of both a contact connection affinity network 1320 and a familial affinity network 1360A-C. User K is also a member of a familial affinity network 1360A-C and a location affinity network 1340. User F 1312, however, in this example embodiment is a member of only the familial affinity network 1360B.

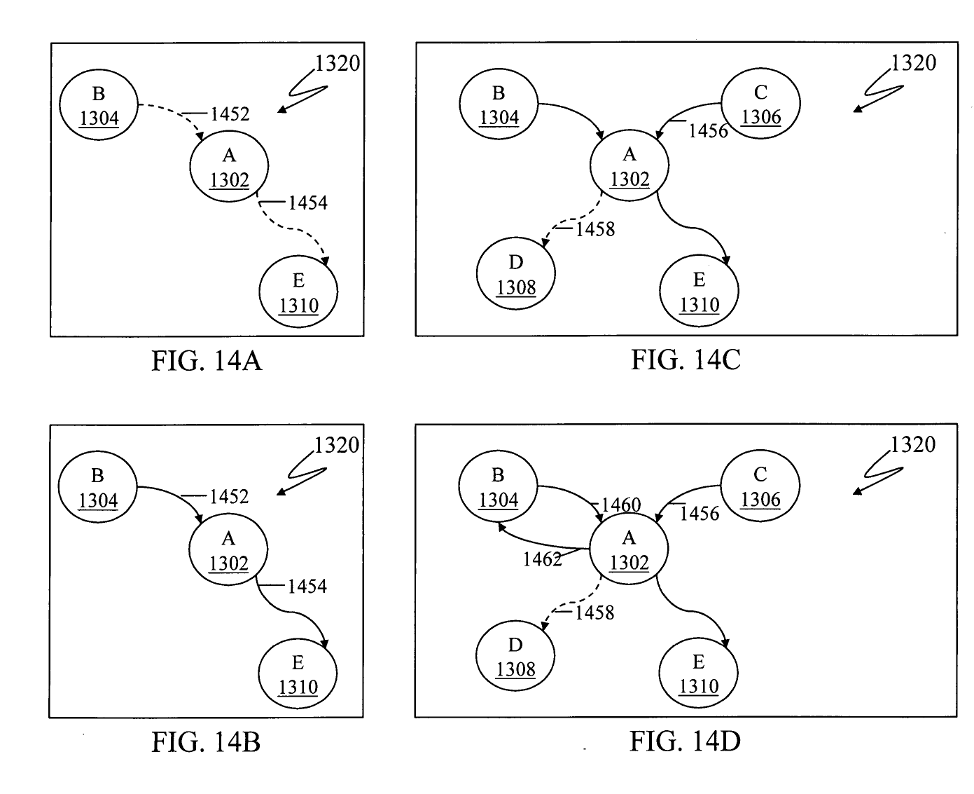

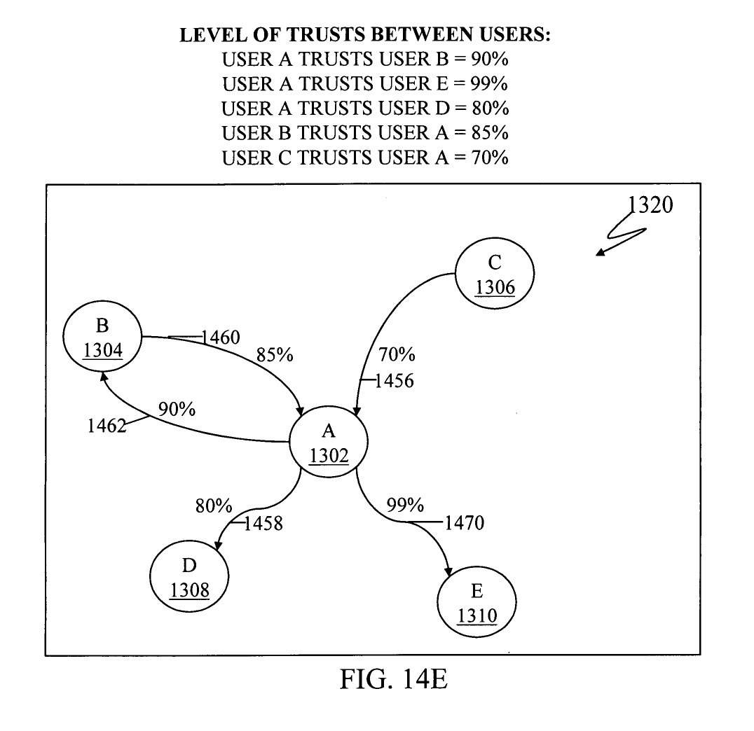

FIGS. 14A-14E are graphical illustrations of how, in one embodiment of the invention, the example contact connection affinity network in a GIK system is created. In this example system, the users of the network have a relationship with each other based on those users that they directly or indirectly know. In one embodiment of the invention, the user network contains a contact connection affinity network type. That is, the various personal networks in a GIK system are interrelated directly or indirectly by indicating who they know and in this example no other affinity network type, such as familial affinity network type or location affinity network type exists in the user network.

In this example embodiment of the invention, a relationship or affinity with another user is only established when an invitation to join an affinity network is accepted. In another embodiment, not shown, acceptance of an invitation is not necessary to establish a relationship.

In this illustrated embodiment, an affiliate of the contact connection affinity network 1320, for example, User B 1304 invites another user to establish an affinity with the inviting user. Each user is graphically shown as a node 1302, 1304, 1306, 1308, 1310 with an accepted relationship shown as a solid line between two users and an unaccepted relationship shown as a dashed line. The origin of a line indicates the inviting user and where the line ends with an arrow shows the invitee. In this example, User B 1304 invites User A 1302 to establish a relationship; User A, however, has not accepted the invitation, as shown by the dashed line 1452. User A 1302 has also invited User E 1310, but User E 1310 has not accepted the invitation. In this example embodiment, the users have not established a relationship with each other. Other embodiments, however, do not require invitations and acceptances to establish relationships.

FIG. 14B, while similar to FIG. 14A, illustrate by example two accepted affinity or relationship invitations, as shown by solid lines 1452, 1454. In the embodiment illustrated in FIG. 14B, the relationships between User B 1304 and User A 1302, and between User A and User E 1310 have been established. User A is one connection away from User B, while User E is one connection away from User A. Users A and B are directly connected, similar to Users A and E. User B 1304, however, is indirectly connected to User E 1310, in this case, two connections away from user E 1310. The connection number or value may be obtained by adding the number of connections between the two users—between Users B 1304 and A 1302 one connection and between Users A 1302 and E 1310 one connection for a total of two connections.

Generally, users invite other users to become part of their network. In this example embodiment, the motivation for an invitation is based on whether a user knows another user, accordingly User B 1304 invited User A because User B knows User A, and User A 1302 invited User E 1310 because User A knows User E. User B 1304 knows User E 1310 indirectly via User A 1302, meaning User E is a friend of a friend that is a friend of User A where User E is a friend of user B.

FIG. 14C shows two more users being added to the network—Users C 1306 and D 1308. In this example, User C 1306 issued an invitation to User A 1302, which was accepted as shown 1456. User A has also issued an unaccepted invitation to User D 1308, shown by the dashed line 1458. User C 1306 is one connection away from User A 702, while User C 1306 is two connections away from User D 1308, User E 1310, and User B 1304.

FIG. 14D is similar to FIG. 14C, but in this case User A 1302 has also issued an invitation to User B 1304, which User B accepted, shown by the solid line 1462. The relationship or affinity weight between Users A 1302 (inviter) and B 1304 (invitee) denoted herein by AB, and the relationship weight between Users B (inviter) and A (invitee), denoted by BA, may be the same or different, depending on system design. Relationship weight in this embodiment is included as part of the attributed defining a relationship. Other attributes may also define relationships.

The relationship/affinity weight may be assigned in various ways. The GIK system, for example, may assign a default relationship weight based on the familial relationship, e.g., siblings have a relationship weight of 100% between each other and 75% between second degree cousins within a familial affinity network. This affinity weight is adjustable by the user. Each relationship, including its associated attributes, is stored in one or more databases for retrieval.

In another embodiment, members of the same affinity network, for example, profession affinity network, automatically have relationships or affinities with all the members of that affinity network and with default relationship weight values. The relationship weight value may be of various scaling ranges, such as zero to one hundred percent, one to five, one to three, etc.

The relationship or affinity weight, in another embodiment, is assigned a default value, for example, based on the number of connections. This value may be adjusted by the user and/or by the GIK system. Attributes affecting relationship or affinity weight, for example, may include a numerical representation of the degree to which User A trusts User B, i.e., a numerical trust value, a scoring of the similarity of user's recommendations, and the distance between two users.

In one embodiment, the GIK system optionally uses a reputation measurement or rating in defining the relationship. This encourages users to supply honest or relatively accurate recommendations on providers and consumables. The reputation rating is intended to reflect the degree of trustworthiness or reliability of users and their recommendations. Optionally, this personal reputation rating or score is viewable by other users via the Web site. In another embodiment, each user is assigned a unique reputation rating with respect to each other. The reputation rating may be assigned or calculated using one or more of the following attributes, as well as other relevant attributes:
Number of users referred to the knowledge system;
Number of accepted friends or affiliates;
Ratio of connection invitations sent versus connection invitations accepted (in one embodiment, a connection invitation is defined as one user asking to share information with another);
Number of validations, e.g., feedbacks, by other members of a user's recommendations. For example, when users search for and then request contact information on businesses or products, the GIK system optionally automatically queries those users later to determine if they ended up buying the products or services, and if so, request a rating. The system then tracks the average or other statistical difference between a user's ratings and ratings provided by other knowledge users in the network. In an example embodiment, the system may automatically remove the mean from recommendations provided by users prior to performing this analysis in order to better ensure that bias is not an issue. Other more complex analytical techniques are also used, including one or more of the following:
Correlation between ratings provided by user and ratings for same provider already on the system;
Frequency with which friends or affiliates of said user act based on or motivated by the user's recommendations as opposed to recommendations of others when both are available in a given search result; and
Complaints against the user by other users on the system.

By way of further example, the system optionally compares recommendations provided by individual users to determine if users are submitting false data to benefit a particular product or business. For example, if one user has rated a vendor a five (5) and the average rating provided by n other user is two (2), the system may assume that the former user has provided fraudulent data. Thus, outlying ratings that differ from the average or median rating by more than a certain threshold can optionally be automatically excluded from appearing on the corresponding Web page or other interface being presented to the user. Optionally, users can also manually specify that reviews and recommendations from one or more selected users are to be filtered out or otherwise not presented to the user.

FIG. 14E is similar to FIG. 14D but showing that User D 1308 has accepted the relationship invitation, shown by the solid line 1458. In this example contact connection affinity network of affiliates, User A 1302 trusts User B's recommendation or User B 1304 ninety percent (90%) of the time, User E's 1310 recommendations ninety-nine percent (99%) of the time, and User D's 1308 recommendations eighty percent (80%) of the time. On the other hand, User B 1304 trusts User A 1302 eighty-five percent (85%) of the time, while User C 1306 trusts User A 1302 seventy percent (70%) of the time. In this example embodiment, ninety-nine percent (99%) is the highest level of trust a user may bestow upon another user. In this example embodiment, the relationship is influenced by the number of connections between users and the weight—level of trust—between the users.

One skilled in the art will recognize that various ways to calculate relationship weight, including the attributes used, may be implemented within the knowledge system 100. In this example embodiment, the relationship between Users A and B 1462 (AB) is 90%, between Users B and A 460 (BA) is 85%, between Users A and D 1458 (AD) is 80%, Users A and E 470 (AE) is 99%, and Users C and A 1456 (CA) is 70%. In one example embodiment of the invention, the relationship between Users C 1406 and D 1408 is derived by obtaining an average which is 75%. Thus, in one example embodiment, the relationship weight between Users C and D is 75%. Other mechanisms of calculating the relationship weight may also be implemented, such as having the attributes weighted. The relationship, in one embodiment, may also be influenced by the affinity network type, thus, a contact connection affinity network type may be weighted more than a familial affinity network type. Other attributes, e.g., user's zip code, user's ratings on a particular category of consumables, and user's gender may also affect the relationship between users. In one embodiment, the relationship or affinity is represented as a real number. Depending also on the affinity network type, the attributes used in defining the relationship may be different from one affinity network type to another.

In one embodiment of the invention, the affinity network type is a combination network type, for example, the affinity network type is both a familial affinity network and a contact connection affinity network type. Relationships are defined, for example, by blood relationship such as mother, father, sibling, second cousins, etc. In this network too, the user may specify who the user directly knows. The relationship between each user is stronger when there is a familial blood relationship and a contact connection.

In a contact connection affinity network, users may optionally also receive and view recommendations from friends of friends, and optionally select more remote “friends,” such as three or four connections away. Thus, for example, if Adam's contact connection affinity network includes Brenda and Charlie, and Brenda's personal affinity network includes Adam, Denise, and Ed, then Brenda and Charlie would be friends, one connection away, of Adam, and Denise and Ed would be friends, two connections away, of Adam, even though Adam does not personally know Denise or Ed. This way, an example knowledge or GIK network consisting only of contact connection affinity network type may search, for example, recommendations provided by friends and friends of friends.

One advantage of having a number of affinity network types is that a user of the GIK system is able to obtain information relevant to that user's needs. For example, a user may be a member of a common interest affinity network and a contact connection affinity network. Let us assume that the user is a doll collector. Although the user may have a number of close personal friends—people that the user knows, those users may not necessarily be doll collectors, too. Thus, when a user queries for doll-related recommendations, for example, what doll to buy or where to purchase it, the user may select the user's common interest affinity network over the contact connection affinity network, because the recommendations provided by the common interest affinity network may prove to be more relevant than those through the user's friends in the user's personal contact connection affinity network.

In one embodiment, a relationship is a multiple attribute entity, such that it may include affinity network type, relationship weight, connection, distance, and level of trust. It may be expressed in a number of ways including as a real number, as a multi-variable data elements or fields, or a combination of number and non-numeric data elements. In another embodiment, a relationship is a single attribute entity.

Modules and databases to implement the user network, as long as the various affinity network types are added as part of the map manager 102. For example, a user database, an affinity network database, the ratings database, etc. are part of the GIK system, which may be also used by the search module to return map-related information, as well as advertising-related information back to the users. Other features may also be added to augment the GIK system, such as an advertising auction and advertising placement features.

The geographic information knowledge (GIK) systems of an embodiment include a method for managing geographically referenced data (GRD). The method of an embodiment includes receiving a search request that includes a defined search area. The method of an embodiment includes providing an extended map based on the search request. The extended map includes geographic areas within the defined search area and outside the defined search area. The method of an embodiment includes providing the GRD. The GRD includes one or more of advertisements, contact information, and review information for one or more entities. The method of an embodiment includes providing map reference information of the GRD on the extended map.

The map reference information of an embodiment includes one or more of location data, addresses, coordinates, and latitude and longitude data of the entities.

The search request of an embodiment includes at least one other search parameter defined by a user.

The method of an embodiment includes receiving one or more searches outside an area of the extended map. The method of an embodiment includes providing a second extended map based on a second user map search definition outside of the extended map.

Providing the GRD of an embodiment that includes the advertisements comprises associating one or more advertisements to one or more advertisement regions within the extended map. The method of an embodiment includes presenting the one or more advertisements according to one or more advertising schemes that define advertising conditions.

The advertising schemes of an embodiment are based on one or more of the extended map, the search area, a geographical location of a requester, demographic information of the requester, information of the search request, a position of a cursor on the extended map, and a geographic location of an advertiser.

The method of an embodiment includes providing the advertisements under one or more of an advertisement purchase and an advertisement auction.

The method of an embodiment includes dividing the geographic areas into one or more regions. The method of an embodiment includes assigning one or more spatial keys to each of the one or more regions. The method of an embodiment includes representing the one or more regions as nodes of a tree. The method of an embodiment includes providing spatial text indexing by associating each of the spatial keys to one more physical locations of the extended map.

The method of an embodiment includes performing queries corresponding to the search request, the queries including one or more of substring queries of the spatial keys and prefix substring queries of the spatial keys.

Associating each of the spatial keys to one more physical locations of the extended map of an embodiment includes associating the spatial keys to one or more of location data, addresses, coordinates, and latitude and longitude data of the physical locations of the entities.

The tree of an embodiment includes one or more of a quad tree, an N-tree, wherein N represents a number of subdivisions per region, a binary space partitioning tree, and a KD-tree, wherein a KD-tree is a multi-dimensional search tree for points in K-dimensional space.

The method of an embodiment includes forming at least one affinity network among a plurality of users, wherein a type of the affinity network includes one or more of familial relationship, common interest, geographical location, personal knowledge profession, user similarity, age, income, demographic data, and gender.

The method of an embodiment includes receiving affinity information from members of the at least one affinity network. The method of an embodiment includes modifying the GRD to include the affinity information.

The method of an embodiment includes controlling the providing of GRD according to the affinity information.

The method of an embodiment includes controlling the geographic areas included in the extended map according to one or more of an amount of commuting within the defined search area, a number of advertisers outside of the defined search area, and demographics of people living within the defined search area.

The GIK systems of an embodiment include a system comprising at least one GIK system coupled to a processor, the GIK system configured to receive a search request that includes a defined search area, wherein the GIK system provides an extended map based on the search request, the extended map including geographic areas within the defined search area and outside the defined search area, the GIK system configured to provide geographically referenced data (GRD) that includes one or more of advertisements, contact information, and review information for one or more entities, the GIK system configured to provide map reference information of the GRD on the extended map.

The system of an embodiment includes at least one remote device coupled to the GIK system via at least one network, wherein the remote device includes a processor, wherein the search request includes at least one other search parameter defined by a user via the remote device.

The system of an embodiment is configured to receive one or more searches outside an area of the extended map and to provide a second extended map based on a second user map search definition outside of the extended map.

The system of an embodiment is configured to provide the GRD that includes the advertisements by associating one or more advertisements to one or more advertisement regions within the extended map, and presenting the one or more advertisements according to one or more advertising schemes that define advertising conditions, wherein the advertising schemes are based on one or more of the extended map, the search area, a geographical location of a requester, demographic information of the requester, information of the search request, a position of a cursor on the extended map, and a geographic location of an advertiser.

The system of an embodiment provides the advertisements under one or more of an advertisement purchase and an advertisement auction.

The system of an embodiment is further configured to divide the geographic areas into one or more regions, assign one or more spatial keys to each of the one or more regions, represent the one or more regions as nodes of a tree, and provide spatial text indexing by associating each of the spatial keys to one more physical locations of the extended map.

The system of an embodiment is further configured to perform queries corresponding to the search request, the queries including one or more of substring queries of the spatial keys and prefix substring queries of the spatial keys.

Associating each of the spatial keys to one more physical locations of the extended map of an embodiment includes associating the spatial keys to one or more of location data, addresses, coordinates, and latitude and longitude data of the physical locations of the entities.

The tree of an embodiment includes one or more of a quad tree, an N-tree, wherein N represents a number of subdivisions per region, a binary space partitioning tree, and a KD-tree, wherein a KD-tree is a multi-dimensional search tree for points in K-dimensional space.

The system of an embodiment is further configured to form at least one affinity network among a plurality of users via a coupling with a plurality of user remote devices, wherein a type of the affinity network includes one or more of familial relationship, common interest, geographical location, personal knowledge profession, user similarity, age, income, demographic data, and gender.

The system of an embodiment is further configured to receive affinity information from members of the at least one affinity network and modify the GRD to include the affinity information.

The map reference information of an embodiment includes one or more of location data, addresses, coordinates, and latitude and longitude data of the entities.

The GIK systems of an embodiment include computer readable medium including executable instructions which, when executed in a processing system, manage geographically referenced data (GRD), by receiving a search request that includes a defined search area. The computer readable medium of an embodiment provides an extended map based on the search request. The extended map of an embodiment includes geographic areas within the defined search area and outside the defined search area. The computer readable medium of an embodiment provides the GRD. The GRD includes one or more of advertisements, contact information, and review information for one or more entities. The computer readable medium of an embodiment provides map reference information of the GRD on the extended map.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

Unless otherwise indicated, the functions described herein are performed by programs or sets of program codes, including software, firmware, executable code or instructions running on or otherwise being executed by one or more general-purpose computers or processor-based systems. The computers or other processor-based systems may include one or more central processing units for executing program code, volatile memory, such as RAM for temporarily storing data and data structures during program execution, non-volatile memory, such as a hard disc drive or optical drive, for storing programs and data, including databases and other data stores, and a network interface for accessing an intranet and/or the Internet. However, the present invention may also be implemented using special purpose computers, wireless computers, state machines, and/or hardwired electronic circuits.

Throughout the following description, the term “Web site” is used to refer to a user-accessible network site that implements the basic World Wide Web standards for the coding and transmission of documents. These network sites may also be accessible by program modules executed in computing devices, such as computers, interactive television, interactive game devices, wireless web-enabled devices, and the like. The standards typically include a language such as the Hypertext Markup Language (HTML) and a transfer protocol such as the Hypertext Transfer Protocol (HTTP). Other protocols may also be used such as file transfer protocol (FTP), wireless application protocol (WAP) and other languages such as the extensible markup language (XML) and wireless markup language (WML). It should be understood that the term “site” is not intended to imply a single geographic location, as a Web or other network site can, for example, include multiple geographically-distributed computer systems that are appropriately linked and/or clustered together. Furthermore, while the following description explains by example an embodiment utilizing the Internet and related protocols, other networks, whether wired or wireless, and other protocols may be used as well.

The databases or other data stores described herein can be combined into fewer databases, or partitioned or divided into additional databases. In addition, the example processes described herein do not necessarily have to be performed in the described sequence, and not all states have to be reached or performed. Various database management systems or data formats may also be used, such as object-oriented database management systems, relational database management systems, flat files, text files, linked lists, arrays, and stacks. Furthermore, flags, Boolean fields, pointers, and other software engineering techniques or algorithmic procedures may be incorporated in the data management system to implement the features of the present invention.

Embodiments of the present invention may reside in the client side, in the server side, or in both places. Such embodiments, for example, program modules may be created using various tools as known in the art. For example, client side programming or manipulation may include programs written in various programming languages or applications, such as C++, Visual Basic, Basic, C, assembly language, FLASH™ from Macromedia, and machine language. Program modules interfacing with web browsers, such as plug-ins and MICROSOFT™ active X controls, Java Scripts, and applets may also be implemented. Server side modules may also be written in programming languages previously mentioned and including other server programming languages, such as Perl, Java, Hypertext Preprocessor (PHP), ColdFusion of Macromedia, etc. Databases shown residing, for example, on the server side may also reside or only reside on the client side. Similarly, databases discussed that may reside on the client side may also reside or only reside in the server side. Client and server refer to the client-server architecture.

What is claimed is:

1. A method for managing geographically referenced data (GRID), comprising:
receiving a search request that includes a defined search area;
providing an extended map based on the search request, the extended map including geographic areas within the defined search area and outside the defined search area;
providing the GRD, wherein the GRD includes one or more of advertisements, contact information, and review information for one or more entities; and
providing map reference information of the GRD on the extended map.

2. The method of claim 1, wherein the map reference information includes one or more of location data, addresses, coordinates, and latitude and longitude data of the entities.

3. The method of claim 1, wherein the search request includes at least one other search parameter defined by a user.

4. The method of claim 1, further comprising:
receiving one or more searches outside an area of the extended map; and
providing a second extended map based on a second user map search definition outside of the extended map.

5. The method of claim 1, wherein providing the GRD that includes the advertisements comprises:
associating one or more advertisements to one or more advertisement regions within the extended map;
presenting the one or more advertisements according to one or more advertising schemes that define advertising conditions.

6. The method of claim 5, wherein the advertising schemes are based on one or more of the extended map, the search area, a geographical location of a requester, demographic information of the requester, information of the search request, a position of a cursor on the extended map, and a geographic location of an advertiser.

7. The method of claim 5, further comprising providing the advertisements under one or more of an advertisement purchase and an advertisement auction.

8. The method of claim 1, further comprising:
dividing the geographic areas into one or more regions;
assigning one or more spatial keys to each of the one or more regions;
representing the one or more regions as nodes of a tree; and
providing spatial text indexing by associating each of the spatial keys to one more physical locations of the extended map.

9. The method of claim 8, further comprising performing queries corresponding to the search request, the queries including one or more of substring queries of the spatial keys and prefix substring queries of the spatial keys.

10. The method of claim 8, wherein associating each of the spatial keys to one more physical locations of the extended map includes associating the spatial keys to one or more of location data, addresses, coordinates, and latitude and longitude data of the physical locations of the entities.

11. The method of claim 8, wherein the tree includes one or more of a quad tree, an N-tree, wherein N represents a number of subdivisions per region, a binary space partitioning tree, and a KD-tree, wherein a KD-tree is a multi-dimensional search tree for points in K-dimensional space.

12. The method of claim 1, further comprising forming at least one affinity network among a plurality of users, wherein a type of the affinity network includes one or more of familial relationship, common interest, geographical location, personal knowledge profession, user similarity, age, income, demographic data, and gender.

13. The method of claim 12, further comprising:
receiving affinity information from members of the at least one affinity network;
modifying the GRD to include the affinity information.

14. The method of claim 13, further comprising controlling the providing of GRD according to the affinity information.

15. The method of claim 1, further comprising controlling the geographic areas included in the extended map according to one or more of an amount of commuting within the defined search area, a number of advertisers outside of the defined search area, and demographics of people living within the defined search area.

16. A system comprising at least one geographic information knowledge (GIK) system coupled to a processor, the GIK system configured to receive a search request that includes a defined search area, wherein the GIK system provides an extended map based on the search request, the extended map including geographic areas within the defined search area and outside the defined search area, the GIK system configured to provide geographically referenced data (GRD) that includes one or more of advertisements, contact information, and review information for one or more entities, the GIK system configured to provide map reference information of the GRD on the extended map.

17. The system of claim 16, further comprising at least one remote device coupled to the GIK system via at least one network, wherein the remote device includes a processor, wherein the search request includes at least one other search parameter defined by a user via the remote device.

18. The system of claim 16, wherein the GIK system is further configured to receive one or more searches outside an area of the extended map and to provide a second extended map based on a second user map search definition outside of the extended map.

19. The system of claim 16, wherein configured to provide the GRD that includes the advertisements comprises associating one or more advertisements to one or more advertisement regions within the extended map, and presenting the one or more advertisements according to one or more advertising schemes that define advertising conditions, wherein the advertising schemes are based on one or more of the extended map, the search area, a geographical location of a requester, demographic information of the requester, information of the search request, a position of a cursor on the extended map, and a geographic location of an advertiser.

20. The system of claim 19, further comprising providing the advertisements under one or more of an advertisement purchase and an advertisement auction.

21. The system of claim 16, wherein the GIK system is further configured to divide the geographic areas into one or more regions, assign one or more spatial keys to each of the one or more regions, represent the one or more regions as nodes of a tree, and provide spatial text indexing by associating each of the spatial keys to one more physical locations of the extended map.

22. The system of claim 21, wherein the GIK system is further configured to perform queries corresponding to the search request, the queries including one or more of substring queries of the spatial keys and prefix substring queries of the spatial keys.

23. The system of claim 21, wherein associating each of the spatial keys to one more physical locations of the extended map includes associating the spatial keys to one or more of location data, addresses, coordinates, and latitude and longitude data of the physical locations of the entities.

24. The system of claim 21, wherein the tree includes one or more of a quad tree, an N-tree, wherein N represents a number of subdivisions per region, a binary space partitioning tree, and a KD-tree, wherein a KD-tree is a multi-dimensional search tree for points in K-dimensional space.

25. The system of claim 16, wherein the GIK system is further configured to form at least one affinity network among a plurality of users via a coupling with a plurality of user remote devices, wherein a type of the affinity network includes one or more of familial relationship, common interest, geographical location, personal knowledge profession, user similarity, age, income, demographic data, and gender.

26. The system of claim 25, wherein the GIK system is further configured to receive affinity information from members of the at least one affinity network and modify the GRD to include the affinity information.

27. The system of claim 16, wherein the map reference information includes one or more of location data, addresses, coordinates, and latitude and longitude data of the entities.

28. Computer readable medium including executable instructions which, when executed in a processing system, manage geographically referenced data (GRD), by:
receiving a search request that includes a defined search area;
providing an extended map based on the search request, the extended map including geographic areas within the defined search area and outside the defined search area;
providing the GRD, wherein the GRD includes one or more of advertisements, contact information, and review information for one or more entities; and
providing map reference information of the GRD on the extended map.
